(19) United States
(12) Patent Application Publication
(10) Pub. No.: US 2025/0129838 A1
(43) Pub. Date: Apr. 24, 2025

(54) FREEWHEEL MECHANISM HAVING A SHAFT

(71) Applicant: Nazif Kama, Fürth (DE)

(72) Inventor: Nazif Kama, Fürth (DE)

(21) Appl. No.: 18/717,829

(22) PCT Filed: Dec. 12, 2022
(86) PCT No.: PCT/IB2022/062056

§ 371 Date: Jun. 7, 2024

(30) Foreign Application Priority Data
Dec. 10, 2021 (DE) 10 2021 006 103.9

(51) Int. Cl. F16H 37/08; F16H 1/46; F16H 3/00

(52) U.S. Cl. CPC F16H 37/0833; F16H 1/46; F16H 3/005

(57) ABSTRACT

The invention is directed to a freewheel mechanism comprising: a) an input shaft, which rotates at an input speed; b) an output shaft, which rotates at an output speed; c) a first differential-gear or planetary-gear system, which is arranged between the two shafts and comprises at least one toothed orbital or planetary gear, which is rotatably mounted in a first orbital-gear or planetary-gear carrier and meshes with two internal toothed rings on two further rotary connections of the first differential-gear or planetary-gear system, the speeds thereof determining the speed of the first orbital-gear or planetary-gear carrier in the first differential-gear or planetary-gear system; d) a second differential-gear or planetary-gear system, which comprises at least one toothed orbital or planetary gear, which is rotatably mounted in a second orbital-gear or planetary-gear carrier and meshes with two internal toothed rings on two further rotary connections of the second differential-gear or planetary-gear system, the speeds thereof determining the speed of the second orbital-gear or planetary-gear carrier in the second differential-gear or planetary-gear system; and e) a housing, in which both or all the differential-gear or planetary-gear systems are accommodated.

### REFERENCE TO PENDING PRIOR PATENT APPLICATIONS

This patent application is a 371 national stage entry of pending prior International (PCT) Patent Application No. PCT/IB2022/062056, filed 12 Dec. 2022 by Nazif Kama for FREEWHEEL MECHANISM HAVING A SHAFT, which patent application, in turn, claims benefit of German Patent Application No. DE 10 2021 006 103.9, filed 10 Dec. 2021.

The two (2) above-identified patent applications are hereby incorporated herein by reference.

### FIELD OF THE INVENTION

The invention is directed to a freewheel mechanism, comprising
a) at least one input shaft rotating at an input speed;
b) at least one output shaft rotating at an output speed;
c) a first differential or planetary gear arranged therebetween, comprising at least one toothed orbital pinion or planetary wheel rotatably mounted in a first orbital gear or planetary gear carrier, which meshes with two internal gear rings on two further rotary connections of the first differential or planetary gear, the speeds of which determine the speed of the first orbital gear or planetary gear carrier in the first differential or planetary gear;
d) a second differential or planetary gear, comprising at least one toothed orbital pinion or planetary wheel rotatably mounted in a second orbital gear or planetary gear carrier, which meshes with two internal gear rings on two further rotary connections of the second differential or planetary gear, the speeds of which determine the speed of the second orbital gear or planetary gear carrier in the second differential or planetary gear; and
e) a housing in which both or all of the differential or planetary gears are accommodated.

### BACKGROUND OF THE INVENTION

A generic arrangement can be found in EP 3 073 149 A1. 34 However, the transmission there requires a comparatively large installation space.

### SUMMARY OF THE INVENTION

The disadvantages of the described prior art result in the problem initiating the invention of further developing a generic freewheel mechanism in such a way that the installation space required thereby is further reduced.

This problem is solved by construction both or all differential or planetary gear units concentrically to a single, common axis of rotation around which the three coaxial rotating parts rotate, i.e. the planetary gear carrier and the two coaxial rotating connections of all differential and planetary gear units.

Since the sun and ring gears and planet gear carriers of all planetary gears as well as the central shafts and planet gear carriers of all differentials rotate around the same central axis of the freewheel mechanism, a freewheel mechanism according to the invention has a very slim shape and can be arranged in a space-saving manner for example within a cylindrical housing. This is useful, among other things, when a freewheel mechanism according to the invention is arranged, for example, in a drive train of a vehicle, in particular of a motor vehicle.

For this purpose, it is particularly useful that both or all differential or planetary gears are constructed with a single, common through shaft, which is rotatably mounted in the housing in the region of its two ends, and which is coupled to one of the three mutually coaxial rotating parts, i.e. to the planetary gear carrier or to one of the two rotating connections, of a differential or planetary gear in such a way that it rotates with it, while all other rotating parts of the differential in question are rotatably mounted on the through shaft.

By using a common shaft to support both or all of the differential or planetary gears, a comparatively slim housing can be constructed which has a central longitudinal axis and can be surrounded by a preferably cylindrical housing whose diameter is only slightly larger than the diameter of the largest differential or planetary gear.

In the current state of the art, separate shafts are provided for the various differential or planetary gears in a gearbox or freewheel. This applies, among others, to FR 516 793, DE 11 2009 02 196 T5, U.S. Pat. No. 3,119,282 A and DE 1 121 939. As a result, different bearings are required in each case, which on the one hand increases the size of the gearbox or the freewheel mechanism and on the other hand can lead to problems with the play of meshing gears or other gearings.

Furthermore, the overall height of a transmission can possibly be further reduced by using a planetary gear transmission instead of at least one differential gear. In a planetary gear transmission, all meshing gears and ring gears lie within a common plane.

In terms of its mode of operation, a differential gear is a special case of a planetary gear, whereby in the Willis equation for the description of a planetary gear, the standard gear ratio i₀, which is defined as follows:

$${i}_{0} = {n}_{1} / {n}_{2} ,$$

is chosen to be equal to −1:

$${i}_{0} = - 1.$$

It has proven to be advantageous that at least one orbital gear carrier or planetary gear carrier of the first or second differential or planetary gear is neither coupled nor integrated with the at least one input shaft nor with the at least one output shaft.

There are several ways in which two differential or planetary gears arranged coaxially to a common axis of rotation can be coupled together: On the one hand, a rotary connection of the first differential or planetary gear, the internal gear ring of which meshes with at least one orbital pinion or planetary wheel of the first differential or planetary gear, should be coupled to one of the three rotary connections of the second differential or planetary gear in such a way that these two coupled rotary connections rotate in the same direction of rotation and preferably at the same speed. This case should be characterized by a coupling factor or a speed transmission ratio of üₖ=+k, or at the same speed by üₖ=+1, where k>0. Such a coupling can be implemented particularly easily by integrating or connecting the rotating parts involved, i.e. by fixing them to one another.

The invention can be further developed in such a way that the two mutually coupled rotary connections of the first and second differential or planetary gear, which rotate at the same speed and in the same direction of rotation due to their coupling, are neither coupled nor integrated with the input shaft nor with the output shaft.

On the other hand, another rotary connection of the first differential or planetary gear, the internal gear ring of which meshes with at least one orbital pinion or planetary wheel of the first differential or planetary gear, should be coupled to another of the three rotary connections of the second differential or planetary gear in such a way that these two coupled rotary connections rotate in opposite directions and, if necessary, at the same speed. This case should be characterized by a coupling factor or a speed transmission ratio of üₖ=−k, or at the same speed by üₖ=−1. The easiest way to achieve such a coupling is to arrange a coupling gear between the rotating parts involved, which is in toothed engagement with both rotating parts. It can also be several such coupling gears which should then all be in engagement with both the one rotating part and the other at the same time. If the axes of rotation of such coupling gears are oriented radially to the central axis or shaft of the freewheel mechanism according to the invention, a coupling factor or a speed transmission ratio üₖ=−1 can be implemented. If, however, the axes of rotation of such coupling gears run parallel to the central axis or shaft of the freewheel mechanism according to the invention, this results in an inactive coupling factor or [rotational] speed transmission ratio of üₖ=−k, but with different speeds, so:

üₖ=−k≠−1.

The invention offers the possibility that one or both or all differential or planetary gears are constructed with crown gears or with bevel gears. This is a typical design for a differential gear.

The freewheel mechanism according to the invention can be set to a fixed transmission ratio ü=ω_{A}/ω_{E}, so that the output speed ω_{A} is:

$${ω}_{A} = \ddot{u} * {ω}_{{E}_{1}}$$

as long as no external torque or counter-torque working in the opposite direction of rotation acts on the output shaft and/or on at least one rotary connection of the second differential or planetary gear.

The invention is further characterized in that in the case of an external torque on the output shaft or on at least one rotary connection of the second differential or planetary gear in the respective output direction of rotation applies:

$$\vert {ω}_{A} \vert > \vert \ddot{u} * {ω}_{E} \vert .$$

A first rotational coupling between a rotary connection not coupled to the respective orbital pinion or planetary gear carrier of two different differential or planetary gears, preferably of the first and second differential or planetary gears, in particular should be set such that their rotational speeds are identical.

A second rotary coupling between two different differential or planetary gears can be selected such that the speeds of the coupled rotary connections are oppositely identical.

A preferred embodiment is characterized in that the input shaft is coupled to a first differential or planetary gear, preferably in a symmetrical manner, i.e. in particular, only to its orbital pinion carrier or planetary gear carrier.

The invention is further developed in such a way that the output shaft is coupled to a second differential or planetary gear, preferably in an asymmetrical manner, i.e. preferably not or not only to its orbital pinion carrier or planetary gear carrier, but optionally also to a rotary connection of the second differential or planetary gear, the internal ring gear of which meshes with at least one toothed orbital pinion or planetary gear.

Furthermore, it is possible for the output shaft to be coupled to a third differential or planetary gear, whereby the third differential or planetary gear is preferably connected to two rotary connections of the second differential or planetary gear is coupled, preferably in an asymmetrical manner, i.e. with its orbital pinion carrier or planetary gear carrier on the one hand and with a rotary connection of the second differential or planetary gear, the internal gear ring of which meshes with at least one toothed orbital pinion or planetary gear of the second differential or planetary gear.

It is recommended that at least one of the two rotary connections of the first differential or planetary gear coupled to the second differential or planetary gear remains unaffected from the outside, so that its speed ω₁₂, ω₁₃ can be freely adjusted, in particular opposite to the other rotary connection of the first differential or planetary gear coupled to the second differential or planetary gear, if necessary, additionally to twice the speed ω₁₁ of the first planetary gear carrier, if a co-torque working in the direction of rotation acts on the output shaft and/or on at least one rotary connection of the second differential or planetary gear, so that under the influence of this co-torque the output speed ω_{A} can increase without the input speed ω_{E} being influenced thereby.

By influencing a single coupling gear between the first and second differential or planetary gear, the freewheel function can be switched off. This can preferably be done by putting the relevant coupling gear into a non-rotatable state in order to switch off the freewheel function, wherein in particular the coupling gear is fastened to a multiply cranked shaft, which in turn is eccentrically mounted in at least one disk, which in turn is rotatably received in a pivotable and/or displaceable ring-shaped lunette.

Other designs are also conceivable for switching off the freewheel function.

On the other hand, it is possible—especially in the case of several input shafts—to provide a switch-off of the freewheel function selectively for different input shafts, i.e. a freewheel function between a first input shaft and the output shaft is switched off, while at the same time a freewheel function between a second input shaft and the output shaft remains possible.

For example, in a hybrid vehicle, the freewheel function between an internal combustion engine and the vehicle wheels could be switched off in order to use the braking effect of the internal combustion engine, while an electric motor running in parallel can continue to go into freewheel mode. However, this would also be possible in reverse, for example if the electric motor is to be switched to braking generator mode and then used as a recuperation brake; in this case, the freewheel function for this electric motor can be switched off, while the freewheel function in relation to a parallel combustion engine is switched off, for example to save petrol. This functionality is completely independent of the type of combustion engine used (e.g. a petrol or diesel engine) and the electric motor used (e.g. DC motor, three-phase asynchronous motor or air coil magnet motor).

A further preferred embodiment is characterized in that at least one coupling between the first differential or planetary gear and the second differential or planetary gear, preferably that coupling whose mutually coupled rotary connections of the first and second differential or planetary gear rotate at the same speed and in the same direction of rotation due to this coupling, in particular both couplings between those differential or planetary gears, is neither accessible nor influenceable from the outside, and preferably internally at most via a pivotable and/or movable ring-shaped lunette, which cooperates with a region of a multi-cranked shaft of a toothed wheel of the coupling in question, which runs eccentrically to the axis of rotation of this toothed wheel.

In a first embodiment of the invention, the common shaft can be designed as an input shaft rotating at an input speed ω_{E}.

On the other hand, it is also possible for the common shaft to be designed as an output shaft rotating at an output speed ω_{A}.

On the other hand, a second and, if necessary, a third input shaft, each rotating with its own input speed ω_{E2}, ω_{E3}, can be provided.

Preferably, the input speeds ω_{E}, ω_{E2}, ω_{3E} of all input shafts on or before the first differential or planetary gear are combined, for example added together or added in a weighted manner.

According to the invention, it can further be provided that the output shaft rotating at an output speed ω_{A} IS coupled to the second, third or a further differential or planetary gear.

The output shaft may be mounted eccentrically to the input shaft, especially when the central shaft functions as the input shaft.

Finally, it corresponds to the teaching of the invention that the housing is rotationally symmetrical.

When combining a drive train of a vehicle with a freewheel mechanism according to the invention, the freewheel mechanism can be switched on in the drive train in such a way that in overrun mode the freewheel function decouples the drive motor from the drive train to the wheels, and/or in such a way that it is switched on between the drive train and a flywheel, and/or in such a way that it is switched on between the drive train and a starter or between a flywheel and a starter.

Further features, details, advantages and effects based on the invention emerge from the subclaims, as well as from the following description of preferred embodiments of the invention and from the drawing. The figures show respectively schematic circuit diagrams for freewheel mechanisms according to the invention.

All types of freewheel gears consist of at least two differentials and/or planetary gears which are coupled together. This coupling is such that basically two operating states are possible:

In the first operating state, the at least one input shaft is driven with a drive torque, and this drive torque is transmitted to the output shaft via the transmission according to the invention and is output there as output torque. There can be a speed ratio between input and output torque, which can be equal to 1 or not equal to 1. In any case, there is a defined speed ratio between at least one input and output shaft.

In the second operating state, freewheeling prevails. In other words, no torque can be introduced at the input shaft, in particular no braking torque, because the transmission according to the invention then instead goes into the freewheel state and the output shaft is decoupled from the drive shaft. There is then no defined speed ratio between the at least one input and output shaft.

### BRIEF DESCRIPTION OF THE DRAWINGS

Further features, advantages, properties and effects based on the invention will become apparent from the following description of some preferred embodiments of the invention and from the drawing. This shows:

FIG. 1 a freewheel mechanism according to the invention with a housing, a central shaft mounted therein, a total of three planetary gears arranged one behind the other along the central shaft and two input shafts arranged on the casing side, the toothed wheels inside the gears of which mesh with two planetary gear carriers of two planetary gears, whereby the housing also serving as a ring gear for one of the three planetary gears, shown in a longitudinal section along the central shaft, with all the rotating parts also being sectioned, although this is not indicated by hatching to improve clarity;

FIG. 2 a further embodiment of a freewheel mechanism according to the invention in a sectional view corresponding to FIG. 1, comprising two planetary gears which are coupled to one another by a common planetary gear carrier, and a differential which is arranged within the common planetary gear carrier, wherein the central shaft is shown as a continuous line, serves as an input shaft and is coupled in a rotationally fixed manner to a connection of the differential, while a toothed wheel inside the gear on a further, decentralized drive shaft parallel to the central shaft meshes with a toothing on the outside of the common planetary gear carrier and the housing also serves as ring gear for a set of planetary gears which are mounted on the common planetary gear carrier;

FIG. 3 another embodiment of a freewheel according to the invention with two input shafts as a further development of the freewheel from FIG. 2, wherein the differential there is replaced by another planetary gear, and wherein the output shaft—as in FIG. 2—is not shown;

FIG. 4 a modified freewheel construction with two potential input shafts as a further development of the arrangement shown in FIG. 2, again without showing the output shaft, comprising two planetary gears and a differential, wherein one of the planetary gears has planetary gears arranged in pairs and meshing with one another;

FIG. 5 an additional embodiment of the invention in a representation corresponding to FIG. 5 as a further development of the freewheel from FIG. 5, wherein the differential there is replaced by another planetary gear;

FIG. 6 a further modified embodiment of a freewheel mechanism according to the invention with two input shafts, a planetary gear and two differentials in a representation corresponding to FIG. 2, wherein the housing serves as a planetary gear carrier for the planetary gear and the shaft of a planetary gear mounted thereon serves as the input shaft, and wherein the output shaft is not shown;

FIG. 7 an embodiment of the invention which is further modified compared to the freewheel according to FIG. 3;

FIG. 8 a revised embodiment of the invention as a further development of the freewheel from FIG. 5, wherein the central shaft simultaneously serves as one of two input shafts and is connected in a rotationally fixed manner to a planet gear carrier of a primary planetary gear, while a second, decentrally mounted input shaft meshes via a pinion with a toothing arranged on the outside of the ring gear and this ring gear of the primary planetary gear simultaneously serves as a sun gear for a secondary planetary gear, the ring gear of which is formed by the housing, while the planet gear carrier of the secondary planetary gear is integrated with the planet gear carrier of the tertiary planetary gear to form a common planet gear carrier, although the tertiary planetary gear has planet gears that mesh with one another in pairs and a sun gear that is integrated with the sun gear of the primary planetary gear, and wherein in this embodiment a decentralized output shaft is shown, which can also be included in a corresponding manner in all other freewheel designs;

FIG. 9 an embodiment of the invention modified compared to the arrangement according to FIG. 8, wherein, however, the central input shaft is coupled in a rotationally fixed manner to the sun gear of the primary planetary gear and the planet gear carrier of the primary planetary gear is integrated or connected to the sun gear of the tertiary planetary gear, and wherein the tertiary planetary gear does not have planet gears meshing with one another in pairs;

FIG. 10 shows a modification of the arrangement shown in FIG. 5, wherein the housing does not form the ring gear of the primary planetary gear, but its sun gear, while the sun gear of the secondary planetary gear does not mesh with the sun gear of the primary planetary gear but is connected to its planet carrier, and while the ring gear of the primary planetary gear is integrated with the planet carrier of the tertiary planetary gear;

FIG. 11 an embodiment of the invention based on the arrangement according to FIG. 10, but with a different design, whereby the planetary gear carriers of the primary and secondary planetary gears are integrated with one another, while the sun gear of the primary planetary gear is formed by the housing and the sun gear of the secondary planetary gear is coupled in a rotationally fixed manner to the central input shaft, and whereby, furthermore, it is not the planetary gears of the tertiary planetary gear that are designed to mesh with one another in pairs, but rather the planetary gears of the secondary planetary gear;

FIG. 12 a further modified design of the invention compared to the embodiment according to FIG. 11, with the difference compared to FIG. 11 that the planet gears of the secondary planetary gear are not designed to mesh with each other in pairs, but have a stepped geometry with an upper region with a larger diameter in FIG. 12 and a lower region with a smaller diameter in FIG. 12, the upper regions of the planet gears meshing with a first sun gear which is fixed to the central input shaft, while the lower regions of the planet gears meshing with a second sun gear which is integrated or connected to the sun gear of the tertiary planet gear carrier;

FIG. 13 an embodiment of a freewheel mechanism according to the invention modified from the arrangement according to FIG. 8, whereby one of the two decentralized input shafts is connected to the central input shaft inside the transmission. Shaft is rotationally coupled to the common sun gear of both planetary gears, while the second, decentralized input shaft is coupled via a pinion to the planet gear carrier of the upper planetary gear;

FIG. 14 an embodiment of the invention modified compared to the freewheel according to FIG. 9 with a total of three planetary gears, whereby the housing simultaneously functions as a planetary gear carrier for the first two planetary gears and each of the two decentralized input shafts has one planetary gear of these two first planetary gear drives, wherein the ring gear of the primary planetary gear simultaneously serves as the sun gear for the secondary planetary gear, while the sun gear of the primary planetary gear is integrated with the planet gear carrier of the tertiary planetary gear and the ring gear of the secondary planetary gear is integrated with the ring gear of the tertiary planetary gear, and finally wherein the sun gear of the tertiary planetary gear is rotationally fixedly coupled to the central shaft serving as the output shaft;

FIG. 15 a further embodiment of the invention derived from the embodiment according to FIG. 14, but with only two planetary gears, wherein two decentralized input shafts do not act on the planetary gears, but drive one of the two planetary gear carriers via a pinion inside the gear, wherein one of these two pinions simultaneously rotates the sun gear of the primary planetary gear coupled to the other input shaft, and wherein the ring gears of both planetary gears are integrated with one another and the sun gear of the secondary planetary gear is connected in a rotationally fixed manner to the central shaft serving as the output shaft; and

FIG. 16 a further embodiment of the invention; and

FIG. 17 a drive train incorporating a freewheel mechanism according to the invention in a schematic representation.

### DETAILED DESCRIPTION OF THE PREFERRED EMBODIMENTS

As can be seen from the drawing, in all freewheel mechanisms the various differential or planetary gears are not only arranged in a common alignment, but are also mounted on a common shaft, which of course is usually only rotationally fixedly coupled to a single rotating part or no more than two rotating parts in order to enable relative speeds of other rotating parts.

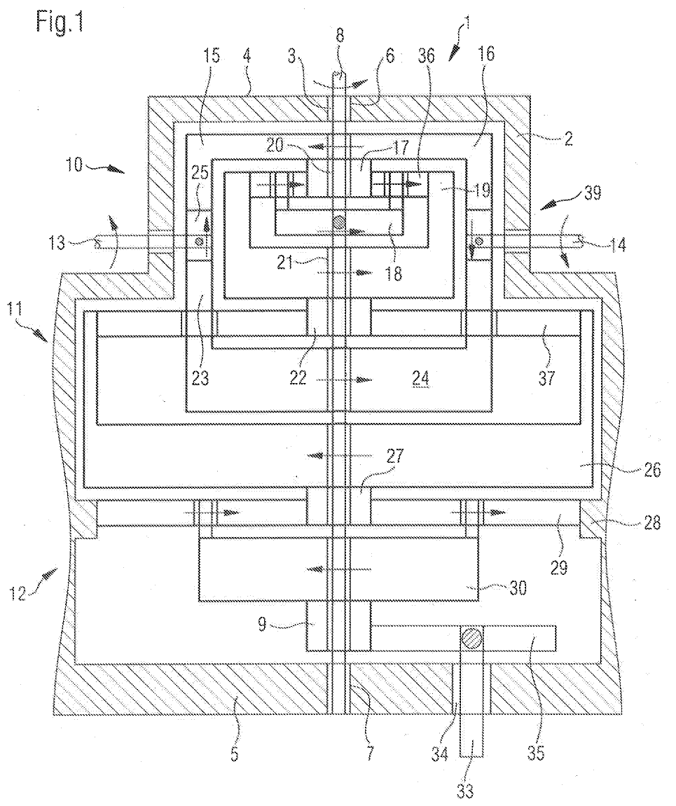

The freewheel mechanism 1 according to FIG. 1 is accommodated in a housing 2. This housing 2 is preferably of cylindrical or partially cylindrical shape, which is constructed rotationally symmetrically around a central shaft 3.

This shaft 3 is rotatably mounted in both end faces 4, 5 of the housing 2 in bearing points 6, 7.

One end 8 of this shaft 3 can be led out at a front side 3 of the housing 2 in order to serve there as an input shaft 8.

An output shaft 33 preferably leaves the housing 2 at the end face 5 opposite the input shaft 8 and can also be rotatably mounted there in a bearing point 34, namely eccentrically to the shaft 3. Within the housing 2 of the freewheel mechanism 1, a toothed wheel 35 is fixed on this output shaft 33, which meshes with an internal toothed wheel 9 of the freewheel mechanism 1 that is concentric with the central shaft 3.

The freewheel mechanism 1 comprises a total of three planetary gears 10, 11, 12. In the example shown, these are arranged one behind the other along the central axis 3, whereby in the following the planetary gear 10 closest to the central input shaft connection 8 and/or coupled to it in terms of rotation may be referred to as the primary planetary gear 10, and then the further planetary gears 11, 12 along the central axis 3 are numbered consecutively, preferably whereby the planetary gear 12 closest to the output shaft 33 and/or coupled to it in terms of rotation should receive the highest or last ordinal number, in the present case the tertiary planetary gear 12. In this context, Latin ordinal numbers are intentionally used in the description in order to avoid confusion between the numbering of epicyclic gears in the context of the claims and German ordinal numbers, because in the context of the claims the numbering of epicyclic gears is done in a rather abstract manner, i.e. based on their mode of operation, whereas in the context of the description a geometric numbering is used which is based on the position of an epicyclic gear within the transmission.

In most of the freewheel mechanisms 1 described in this patent application, there are three planetary and/or differential gears 10, 11, 12.

In this case, a middle gear, in this case the secondary planetary and/or differential gear 11, is usually coupled to one of the outer gears, in this case the primary planetary and/or differential gear 10, via two independent paths.

The coupling of the middle planetary and/or differential gear 11 to the other, outer planetary and/or differential gear, in the present case the tertiary planetary and/or differential gear 12, on the other hand, often takes place via only a single path. This latter planetary and/or differential gear, in this case the tertiary planetary and/or differential gear 12, is not required for the pure freewheel function, but serves primarily to adjust the transmission ratio between the input and output shaft 8, 33.

The actual freewheel function is created by the double coupling between two (adjacent) planetary and/or differential gears, in this case the primary and secondary planetary and/or differential gears 10, 11, as explained below. In particular, these two couplings occur between the planetary and/or differential gears involved in the freewheel function, in the present case the primary and secondary planetary and/or differential gears 10, 11, with different directions of rotation. In other words, while the rotating parts coupled to one another in a first way are, for example, coupled to one another in such a way that they rotate in the same direction of rotation about the central axis 3, the rotating parts of the planetary and/or differential gears 10, 11 involved coupled to one another in a second way are coupled to one another in such a way that they rotate in opposite directions of rotation about the central axis 3. If the transmission ratios are standardized, the coupling on the first path has the transmission ratio üₖ=+1, and on the second path the transmission ratio üₖ=−1.

In addition to the input shaft 8, the freewheel mechanism 1 shown in FIG. 1 has two further input shafts 13, 14, which are also mounted in the housing 2, but run neither coaxially nor parallel to the central shaft 3, but extend radially away from it, in particular in diametrically opposite directions.

The rotation of the two input shafts 13, 14 is synchronized by a gear ring 15 concentric with the shaft 3 on a disk 16, which in turn[/itself] is rotationally fixedly connected to the sun gear 17 of the primary, input-side planetary gear 10. The rotation of the input shaft 8 or the identical shaft 3 is transmitted to the planet gear carrier 18 of the primary planetary gear 10, which—as in the other figures—is represented by a hatched circle at the intersection point of these parts 3, 18.

The sun gear 17 as well as the ring gear 19 of the primary planetary gear 10 are mounted on the shaft 3 in bearings 20, 21.

The ring gear 19 of the primary planetary gear 10 is connected in a rotationally fixed manner to the sun gear 22 of the secondary planetary gear 11, with identical direction of rotation, i.e. the ring gear 19 of the primary planetary gear 10 and the sun gear 22 of the secondary planetary gear 11 rotate in the same direction of rotation around the central axis 3. The transmission ratio between the ring gear 19 and the sun gear 22 in this case is üₖ=+1, since both rotate with the same angular velocity.

In the present case, the ring gear 19 and the sun gear 22 are simply integrated or connected to each other, e.g. screwed, welded, soldered or glued. Such an integration or connection of two rotating parts into a single part is the simplest way to couple the two rotating parts with a transmission ratio of üₖ=+1.

A second coupling between the primary planetary gear 10 and the secondary planetary gear 11 is via a second ring gear 23 on top of a disk which acts as a planetary gear carrier 24 of the secondary differential 11. Since the gear ring 23 meshes from below with the gear wheels 25 inside the transmission on the two auxiliary input shafts 13, 14, while the gear ring 15 on the disk 16 meshes from above with these gear wheels 25, the two gear rings 15, 23 always rotate in opposite directions, as shown by the arrows in FIG. 1.

While the sun gear 22 of the secondary planetary gear 11 rotates in the same direction as the ring gear 19 of the primary planetary gear 10, the planet gear carrier 24 of the secondary planetary gear 11 always rotates in the opposite direction to the sun gear 17 of the primary planetary gear 10 about the central axis 3, namely with oppositely equal angular velocities. The transmission ratio between the sun gear 17 and the planet gear carrier 24 is therefore üₖ=−1 in the present case.

Such a coupling of two rotating parts via one or more pinions or gears arranged between them, which however mesh with both coupled rotating parts at the same time, is the simplest way to couple the rotating parts involved with a transmission ratio of üₖ=−k.

Such a double coupling between the two planetary gears 10, 11—once rotating in the same direction of rotation, but once in opposite directions of rotation—leads to a freewheel effect.

The two coupling paths must run concentrically to each other, i.e. one coupling path radially further inwards, the other coupling path radially further outwards. In the present example, the üₖ=+1 coupling takes place relatively centrally via the connection or integration of the ring gear 19 with the sun gear 22, while the üₖ=−1 coupling takes place radially further outwards via the coupling gears 25 there.

The ring gear 26 of the secondary planetary gear 11 serves as the internal output of the actual freewheel mechanism 1. In order to obtain a different gear ratio between the input shaft 8 and the output shaft 33, a tertiary planetary gear 12 is also provided. Its sun gear 27 is rotationally fixedly connected to the ring gear 26 of the secondary planetary gear 11. The housing 2 itself, with its all-round toothing 28, serves as a ring gear for this tertiary planetary gear 12. The planet gears 29 of this tertiary planetary gear 12 are mounted on a planet gear carrier 30, which in turn is connected in a rotationally fixed manner to the further toothed wheel 9.

The tertiary planetary gear 12 does not contribute to the freewheel function, but only serves to specify a suitable gear ratio between the input shaft 8 and the output shaft 33.

In the example shown, the input shaft 8 and the output shaft 33 have the same direction of rotation.

In this embodiment, the two disks 16, 24 together with the two gears 25 arranged between them could also be viewed as a differential gear 39, so that in this embodiment there would then be a total of four epicyclic gears 10, 11, 12, 39; however, the differential gear 39 only contributes indirectly to the freewheel function by ensuring a reversal of the direction of rotation in the coupling between the sun gear 17 of the primary planetary gear 10 and the planet gear carrier 24 of the secondary planetary gear 11.

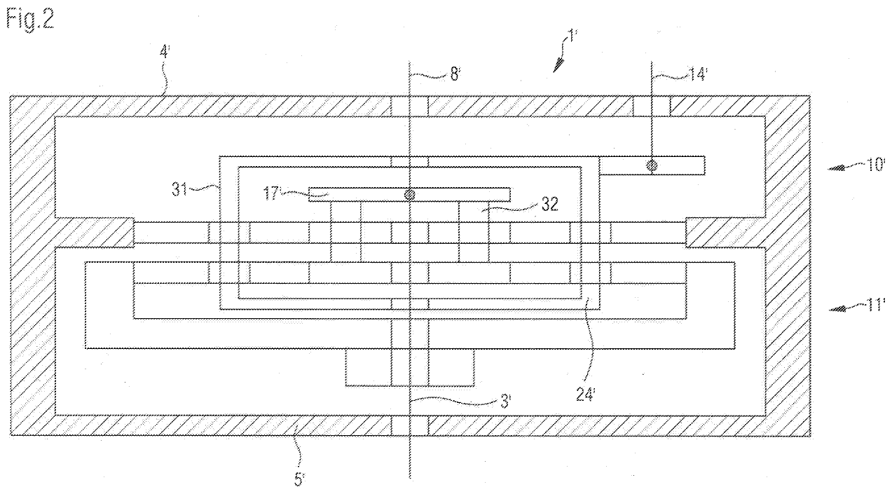

In the embodiment according to FIG. 2, the primary planetary gear 10 is replaced by a differential gear 10′.

The secondary planetary gear 11′ is, however, present.

Instead of the sun gear 17, in the freewheel mechanism 1′, an upper, toothed circular disk 17′ of the primary differential gear 10′ is connected in a rotationally fixed manner to the shaft 3 or the input shaft 8.

In this embodiment, there is a cage 31 inside the gear, in which the bevel or crown gears 32 of the primary differential gear 10′ are mounted on the one hand, and which is simultaneously connected in a rotationally fixed manner to the planet gear carrier 24′ of the secondary planetary gear 11′.

The mode of action is as follows:

When a motor connected to the input shaft 8 rotates, it can directly move the power to the output. The planet carrier 24′ clings to the fixed ring gear.

When freewheeling occurs, relative speeds are automatically compensated. The engine can drive or stop.

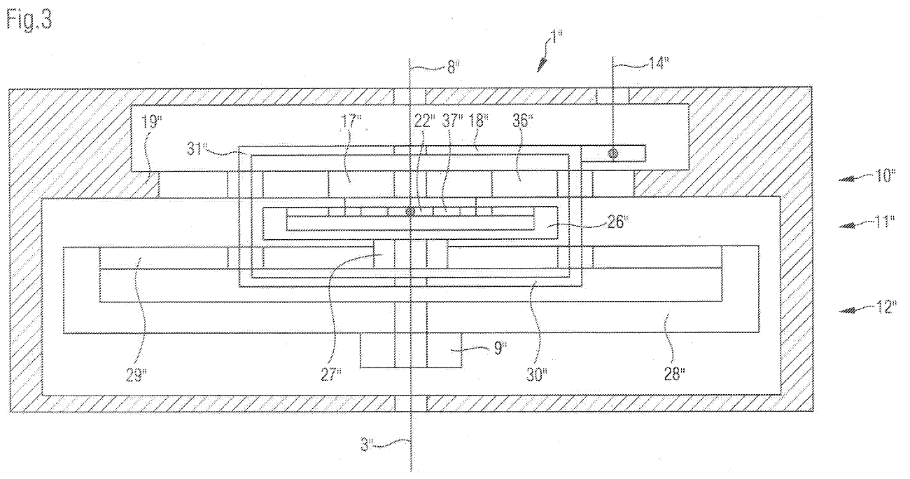

In the embodiment according to FIG. 3, there are also three planetary gears 10″, 11″, 12″, similar to FIG. 1.

However, there is a common cage 31″ in the form of two interconnected planetary gear carriers 18″, 30″ of two planetary gears 10″, 12″, which can be rotated by an auxiliary input shaft 14″. This common cage 31″ provides a first coupling path between the planetary gear carriers 10″, 12″ involved in the freewheel function with a speed transmission ratio of üₖ=+1.

In addition, there is a second coupling path from the sun gear 17″ of the primary planetary gear 10″ via the secondary planetary gear 11″ to the sun gear 27″ of the tertiary planetary gear 12″. This is designed in such a way that a speed transmission ratio −ü with a negative sign. In contrast to the embodiment 1′ according to FIG. 2, however, the transmission ratio is not üₖ=−1, but üₖ=−k≠−1, where k>0. In particular, the planet gears 37″ ensure that the ring gear 26″ of the secondary planetary gear 11″, which is connected to the sun gear 27″ of the tertiary planetary gear 12″, moves in the opposite direction to its sun gear 22″.

In the example shown, the sun gear 17″ of the primary planetary gear 10″ simultaneously serves as the planet gear carrier 24″ of the secondary planetary gear 11″.

The central shaft 3″ serving as input shaft 8″ is connected in a rotationally fixed manner to the sun gear 22″ of the secondary planetary gear 11″.

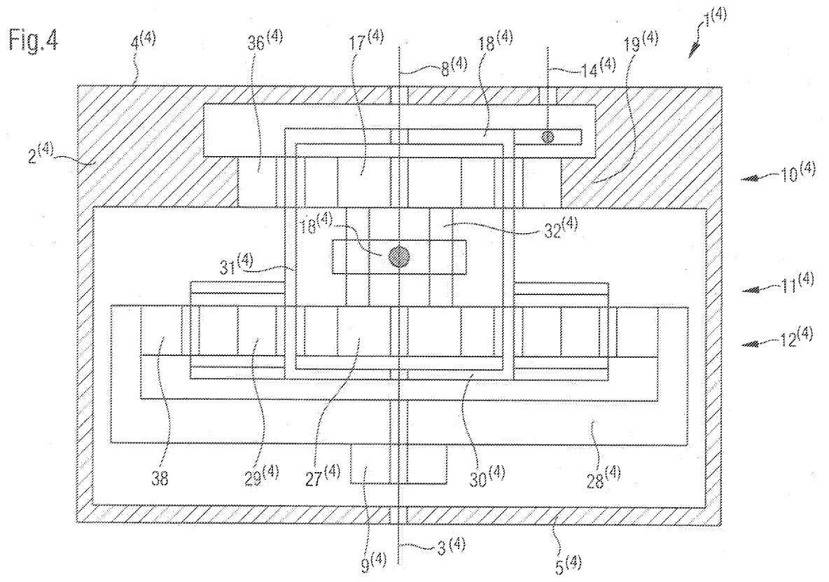

In the embodiment according to FIG. 4, there is—seen along the central shaft 3⁽⁴⁾—a primary epicyclic gear 10⁽⁴⁾ in the form of a planetary gear, a secondary epicyclic gear 11⁽⁴⁾ in the form of a differential gear, and a tertiary epicyclic gear in the form of a planetary gear 12⁽⁴⁾.

In this design, the primary and tertiary epicyclic gears 10⁽⁴⁾, 12⁽⁴⁾, i.e. the two planetary gears 10⁽⁴⁾, 12⁽⁴⁾, play a key role in the freewheel function.

These two planetary gears 10⁽⁴⁾, 12⁽⁴⁾ are coupled to each other in two ways, namely through the planet gear carriers 18⁽⁴⁾, 30⁽⁴⁾ which are integrated into a common “cage” 31⁽⁴⁾—this is the +1 coupling, i.e. the coupling with a transmission factor üₖ=+1, because both planet gear carriers 18⁽⁴⁾, 30⁽⁴⁾ rotate in the same direction around the central axis 3⁽⁴⁾.

The −1-coupling is provided—similarly to the differential 39 in the embodiment according to FIG. 1—by the differential gear 11⁽⁴⁾, whose two disks are each integrated with one of the two sun gears 17⁽⁴⁾ and 27⁽⁴⁾, while the planetary gears in the form of the crown gears 32⁽⁴⁾—similarly to the gears 25 in FIG. 1—ensure the reversal of the direction of rotation, thus establishing the transmission ratio of −1 between the two sun gears 17⁽⁴⁾ and 27⁽⁴⁾.

The output shaft—not shown in this embodiment—is coupled in a rotationally fixed manner to the ring gear 28⁽⁴⁾ of the tertiary epicyclic gear 12⁽⁴⁾ via an internal gear pinion which meshes with the pinion 9⁽⁴⁾. Planetary gears 29⁽⁴⁾ and 38, which mesh with each other in pairs, are provided on the planetary gear carrier 30⁽⁴⁾, which causes a reversal of the direction of rotation between the sun gear 27⁽⁴⁾ and the ring gear 28⁽⁴⁾, but which has no influence on the freewheel function.

In this freewheel mechanism 1⁽⁴⁾, the idler gear carrier 18⁽⁴⁾ of the differential gear 11⁽⁴⁾ is driven via the central shaft 3⁽⁴⁾ which serves as the input shaft 8⁽⁴⁾; a power take-off 14⁽⁴⁾ acts on the planet carrier cage 31⁽⁴⁾.

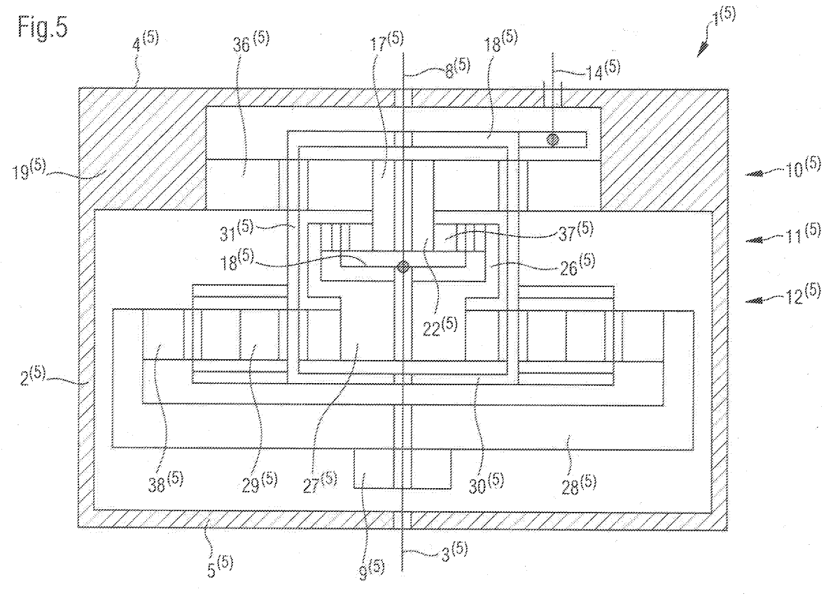

The freewheel mechanism 1⁽⁵⁾ according to FIG. 5 differs from the freewheel mechanism 10⁽⁴⁾ according to FIG. 4 mainly in that the differential gear 11⁽⁴⁾ of FIG. 4 is replaced here by a planetary gear 11⁽⁵⁾.

The +1-coupling, which means the same direction of rotation, is provided by the common cage 31⁽⁵⁾, which integrates the two planetary gear carriers 18⁽⁵⁾ and 30⁽⁵⁾ of the two planetary gears 10⁽⁵⁾ and 12⁽⁵⁾ that are involved in the freewheel function.

The rotational direction-changing üₖ=−k-coupling, on the other hand, is provided by the secondary or middle planetary gear 11⁽⁵⁾, whose planetary gears 37⁽⁵⁾ ensure that the sun gears 17⁽⁵⁾, 22⁽⁵⁾ integrated with each other rotate in the opposite direction to the sun gear 27⁽⁵⁾ integrated with the ring gear 26⁽⁵⁾, certainly also at different speeds.

In this freewheel mechanism 1⁽⁵⁾, the planet carrier 24⁽⁵⁾ of the secondary planetary gear 11⁽⁵⁾ is driven via the central shaft 3⁽⁵⁾, which serves as the input shaft 8⁽⁵⁾; a auxiliary drive 14⁽⁵⁾ acts on the planet carrier cage 31⁽⁵⁾.

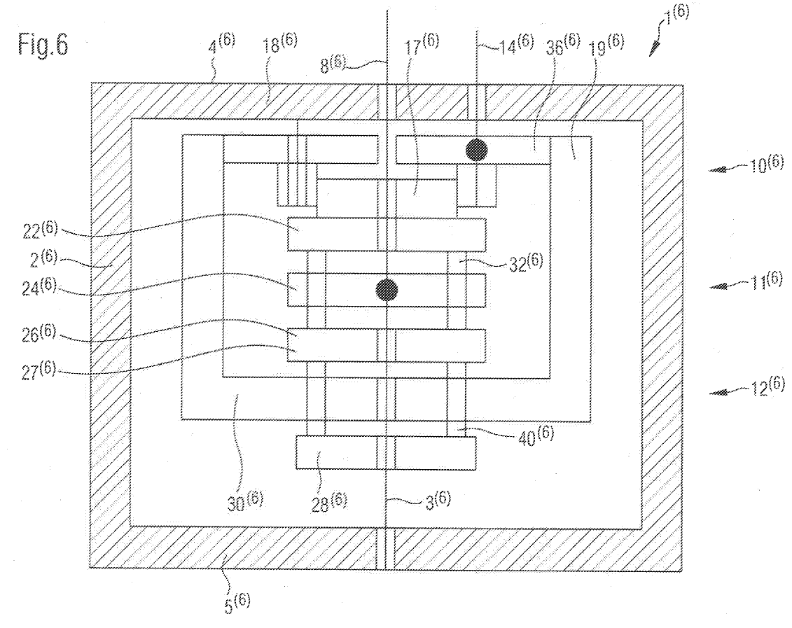

The freewheel mechanism 1⁽⁶⁾ according to FIG. 6 also comprises three epicyclic gears 10⁽⁶⁾, 11⁽⁶⁾, 12⁽⁶⁾, of which the primary one is designed as a planetary gear 10⁽⁶⁾ and the other two as differential gears 11⁽⁶⁾, 12⁽⁶⁾.

The planet gears 36⁽⁶⁾ of the primary planetary gear 10⁽⁶⁾ have a stepped geometry with a larger diameter in the upper area and a smaller diameter in the lower area. However, this gradation has no influence on the freewheel function, but mainly on the overall gear ratio of the freewheel mechanism 1⁽⁶⁾.

In this transmission design, the freewheel function is fulfilled jointly by the primary and tertiary epicyclic gears 10⁽⁶⁾ and 12⁽⁸⁾.

The rotational direction-true +1-coupling between these two planetary gears 10⁽⁶⁾ and 12⁽⁶⁾ is achieved by the fact that the ring gear 19⁽⁶⁾ of the planetary gear 10⁽⁶⁾ is integrated into a single part with the planetary gear carrier 30⁽⁶⁾ of the last differential gear 12⁽⁶⁾, so that the planetary gear carrier 30⁽⁶⁾ of the differential gear 12⁽⁶⁾ is connected to the same direction of rotation and speed rotates like the ring gear 19⁽⁶⁾ of the planetary gear 10⁽⁶⁾.

The rotational direction-inverting −1-coupling between the epicyclic gears 10⁽⁶⁾ and 12⁽⁶⁾ involved in the freewheel function is effected by the epicyclic gear 11⁽⁶⁾ arranged between them. The upper, disc-shaped rotary connection 22⁽⁶⁾ of the centrally arranged differential 11⁽⁸⁾ in FIG. 6 is connected or integrated with the sun gear 17⁽⁶⁾ of the planetary gear 10⁽⁶⁾, while the lower, disc-shaped rotary connection 26⁽⁶⁾ of the centrally arranged differential 11⁽⁶⁾ in FIG. 6 is integrated with the upper, disc-shaped rotary connection 27⁽⁶⁾ of the lowest or output-side differential 12⁽⁶⁾ in FIG. 6. The bevel or crown gears 32⁽⁶⁾ rolling between these two rotary connections 22⁽⁶⁾, 27⁽⁸⁾ of the centrally arranged differential 11⁽⁶⁾ ensure the necessary reversal of the direction of rotation or the rotation inverting −1 coupling between the two outermost epicyclic gears 10⁽⁶⁾, 12⁽⁶⁾.

The main input shaft 8⁽⁶⁾, which is integrated with the central shaft 3⁽⁶⁾, drives the recirculating cage 18⁽⁶⁾ of the centrally arranged differential gear 10⁽⁶⁾; in addition, a secondary input shaft 14⁽⁶⁾ acts directly on one of the planetary gears 36⁽⁶⁾. The housing 2⁽⁶⁾, in which this driven planetary gear 36⁽⁶⁾—is mounted together with other planetary gears 36⁽⁶⁾—, therefore forms the planetary gear carrier 18⁽⁶⁾ of the planetary gear 10⁽⁶⁾.

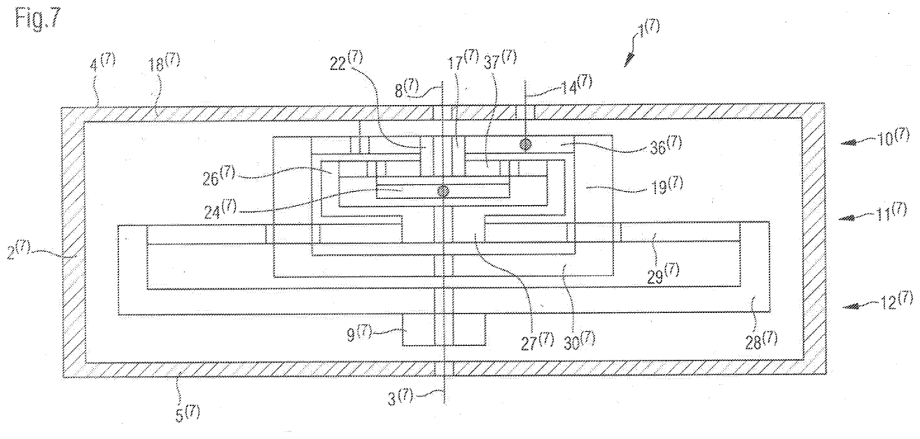

The embodiment of a freewheel mechanism 1⁽⁷⁾ according to FIG. 7 largely corresponds to the embodiment according to FIG. 3. As there, there are also three planetary gears 10⁽⁷⁾, 11⁽⁷⁾, 12⁽⁷⁾, of which the secondary planetary gear 11⁽⁷⁾ and the tertiary planetary gear 12⁽⁷⁾ are wired in the same way as the corresponding planetary gears 11″ and 12″ of the embodiment according to FIG. 3. However, the coupling to the primary planetary gear 10⁽⁷⁾ is different.

The freewheel function is performed jointly by the primary and tertiary planetary gears 10⁽⁷⁾ and 12⁽⁷⁾. These are linked in two ways:

A first coupling having the same rotation sense, +1 coupling is achieved by integrating the ring gear 19⁽⁷⁾ of the primary planetary gear 10⁽⁷⁾ with the planet gear carrier 30⁽⁷⁾ of the tertiary planetary gear 12⁽⁷⁾ into a single part or by connecting them to one another.

A second, rotation-inverting üₖ=−k coupling is provided by the middle or secondary planetary gear 11⁽⁷⁾, whose sun gear 22⁽⁷⁾ is integrated or connected to the sun gear 17⁽⁷⁾ of the primary planetary gear 10⁽⁷⁾, while its ring gear 19⁽⁷⁾ is integrated or connected to the sun gear 27⁽⁷⁾ of the tertiary planetary gear 12⁽⁷⁾. Since the ring gear 26⁽⁷⁾ rotates in the opposite direction to the sun gear 22⁽⁷⁾ due to the planetary gears 37⁽⁷⁾ arranged in between, the desired reversal of the direction of rotation takes place here, resulting in the second, rotation inverting −k-coupling.

In contrast to the embodiment according to FIG. 6, however, the transmission ratio üₖ in the rotational direction inverting branch is not equal to −1, but deviates from it.

In the freewheel mechanism 1⁽⁷⁾ according to FIG. 7, the housing 2⁽⁷⁾ serves as the planet gear carrier 18⁽⁷⁾.

The main drive is via the central main input shaft 8⁽⁷⁾ and the central shaft 3⁽⁷⁾ integrated with it via the planetary gear carrier 24⁽⁷⁾ of the secondary planetary gear 11⁽⁷⁾, as a secondary drive, one of the planetary gears 36⁽⁷⁾ of the primary planetary gear 10⁽⁷⁾ can be set in rotation via a secondary input shaft 14⁽⁷⁾.

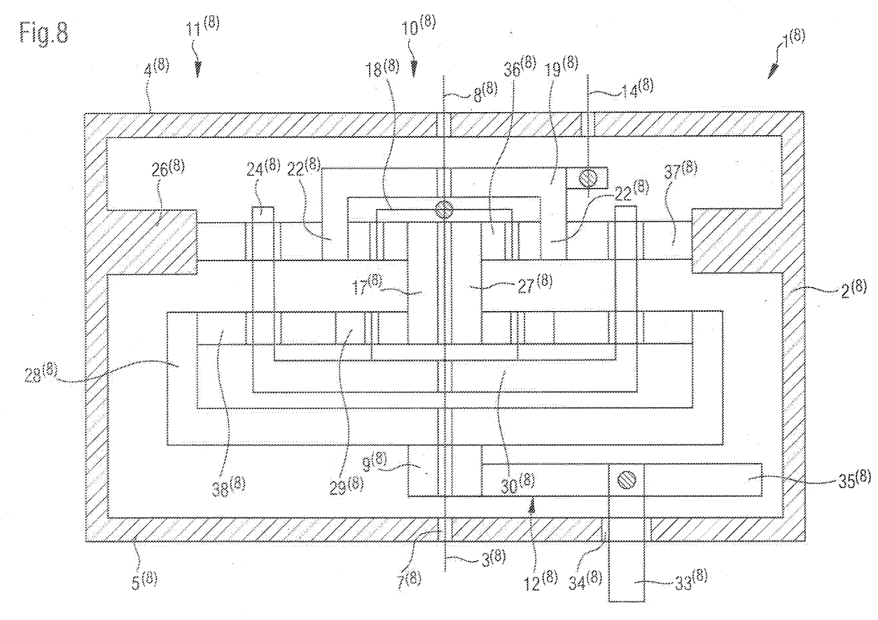

In the freewheel mechanism 1⁽⁸⁾ according to FIG. 8, three planetary gears 10⁽⁸⁾, 11⁽⁸⁾, 12⁽⁸⁾ are provided, the first two of which 10⁽⁸⁾, 11⁽⁸⁾ are arranged in a common plane, radially into each other, while the tertiary planetary gear 12⁽⁸⁾ is offset in the axial direction.

The ring gear 19⁽⁸⁾ of the primary, radially inner planetary gear 10⁽⁸⁾ is integrated with the sun gear 22⁽⁸⁾ of the secondary, radially outer planetary gear 11⁽⁸⁾ to form a common rotating part.

At the same time, the sun gear 17⁽⁸⁾ of the primary planetary gear 10⁽⁸⁾ is integrated with the sun gear 27⁽⁸⁾ of the tertiary planetary gear 12⁽⁸⁾.

In addition, the planetary gear carrier 24⁽⁸⁾ of the secondary planetary gear 11⁽⁸⁾ is integrated with the planetary gear carrier 30⁽⁸⁾ of the tertiary planetary gear 12⁽⁸⁾. This common planetary gear carrier 24⁽⁸⁾, 30⁽⁸⁾ can be driven externally via a secondary input shaft 14⁽⁸⁾.

The main input shaft 8⁽⁸⁾ drives the planetary gear carrier 18⁽⁸⁾ of the primary planetary gear 10⁽⁸⁾.

The freewheel function is performed jointly by the secondary and tertiary planetary gears 11⁽⁸⁾, 11⁽⁸⁾.[Bitte überprüfen!] For this purpose, they are linked together in two ways:

A first, rotational sense-maintaining +1 coupling is achieved via the common planetary gear carrier 24⁽⁸⁾, 30⁽⁸⁾.

A second, counter-rotating coupling is provided by the primary planetary gear 10⁽⁸⁾, which is coupled to the other two planetary gears 11⁽⁸⁾, 12⁽⁸⁾, via the integrated ring gear/sun gear 19⁽⁸⁾, 17⁽⁸⁾ with the secondary planetary gear 11⁽⁸⁾, and via the integrated sun gear 17⁽⁸⁾, 27⁽⁸⁾ with the tertiary gear. Due to the planetary gears 36⁽⁸⁾ arranged between the sun gear and the ring gear 17⁽⁸⁾, 19⁽⁸⁾, the transmission ratio üₖ=−k has a negative sign. However, the transmission ratio üₖ=−k is not neutral in terms of magnitude, i.e. not üₖ=−1, because the sun gear 17⁽⁸⁾ has a smaller diameter than the ring gear 19⁽⁸⁾.

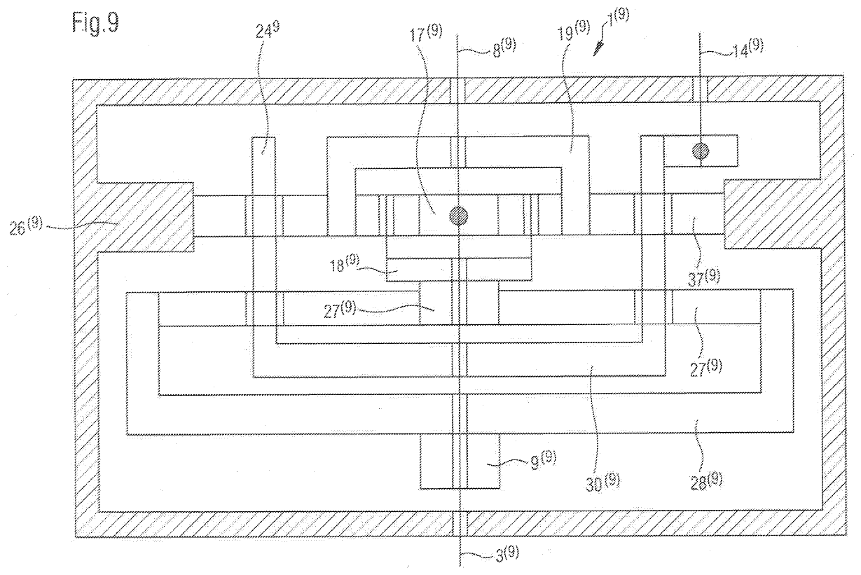

The freewheel mechanism 1⁽⁹⁾ from FIG. 9 has a high degree of similarity to the freewheel mechanism 1⁽⁸⁾ according to FIG. 8.

Of three planetary gears 10⁽⁹⁾, 11⁽⁹⁾, 12⁽⁹⁾, the first two planetary gears 10⁽⁹⁾, 11⁽⁹⁾ are completely identical to the corresponding planetary gears 10⁽⁸⁾, 11⁽⁸⁾ of the freewheel mechanism 1⁽⁸⁾ from FIG. 8.

The rotational direction-maintaining +1 coupling between the secondary and tertiary planetary gear 11⁽⁹⁾, 12⁽⁹⁾ also corresponds completely to the corresponding coupling in the arrangement according to FIG. 8.

On the other hand, the coupling between the primary and tertiary planetary gear 10⁽⁹⁾, 12⁽⁹⁾ is different from the previously described embodiment.

This is because the two sun gears 17⁽⁹⁾, 27⁽⁹⁾ are not coupled to one another, but the planet gear carrier 18⁽⁹⁾ of the primary planetary gear 10⁽⁹⁾ is connected to the sun gear 27⁽⁹⁾ of the tertiary planetary gear 12⁽⁹⁾, while the sun gear 17⁽⁹⁾ of the primary planetary gear 10⁽⁹⁾ is rotationally fixedly connected to the central shaft 3⁽⁹⁾ and is driven via this by the input shaft 8⁽⁹⁾.

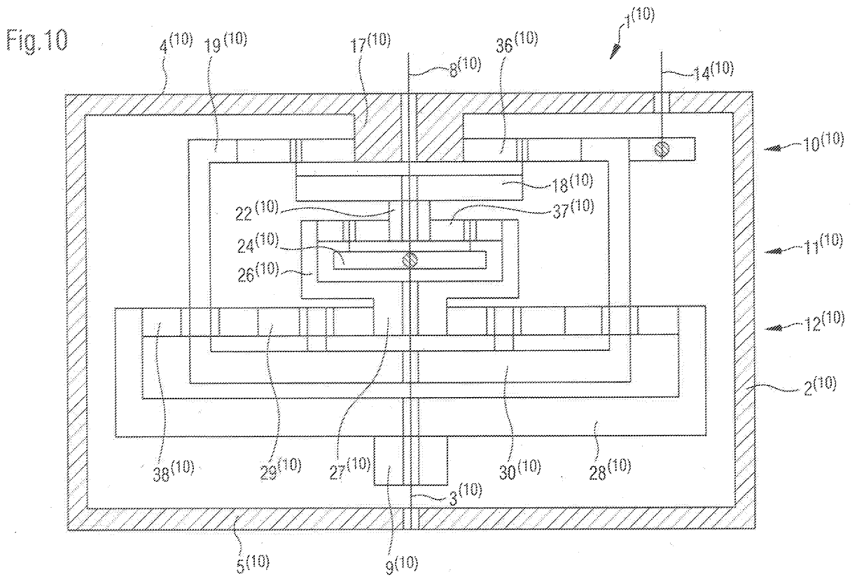

The freewheel mechanism 1⁽¹⁰⁾ according to FIG. 10 represents a modification of the arrangement shown in FIG. 5, and like those comprises three planetary gears 10⁽¹⁰⁾, 11⁽¹⁰⁾, 12⁽¹⁰⁾, which are arranged one behind the other in the axial direction of a central shaft 3⁽¹⁰⁾ The freewheel function is generated by the primary and tertiary planetary gears 10⁽¹⁰⁾, 12⁽¹⁰⁾ together. For this purpose, they are linked in two ways:

A first, rotational sense-maintaining coupling with the transmission ratio üₖ=+1 is created by the fact that the ring gear 19⁽¹⁰⁾ of the primary planetary gear 10⁽¹⁰⁾ is integrated or connected to the planet gear carrier 30⁽¹⁰⁾ of the tertiary planetary gear 12⁽¹⁰⁾ to form a common part.

A second, rotational direction inverting coupling with a transmission ratio üₖ=−k is obtained via the middle planetary gear 11⁽¹⁰⁾, which is coupled to the other two planetary gears 10⁽¹⁰⁾ and 12⁽¹⁰⁾ which are directly involved in the freewheel function, namely on the one hand by its sun gear 22⁽¹⁰⁾ being integrated or connected to the planet gear carrier 18⁽¹⁰⁾ of the primary planetary gear 10⁽¹⁰⁾, and on the other hand by its ring gear 26⁽¹⁰⁾ being integrated or connected to the sun gear 27⁽¹⁰⁾ of the tertiary planetary gear 12⁽¹⁰⁾.

Due to the planetary gears 37⁽¹⁰⁾ arranged in between, the sun gear 22⁽¹⁰⁾ of the secondary planetary gear 11⁽¹⁰⁾ always rotates in the opposite direction of rotation to its ring gear 26⁽¹⁰⁾, and this reversal of rotation has the consequence that the sun gear 26⁽¹⁰⁾ of the tertiary planetary gear 12⁽¹⁰⁾ always rotates in the opposite direction to the planetary gear carrier 18⁽¹⁰⁾ of the primary planetary gear 10⁽¹⁰⁾.

In the freewheel mechanism 1⁽¹⁰⁾, the central shaft 3⁽¹⁰⁾ is rotationally fixedly coupled to the planetary gear carrier 24⁽¹⁰⁾ of the secondary planetary gear 11⁽¹⁰⁾ and thereby transmits the drive torque introduced at the input shaft 8⁽¹⁰⁾ to this planetary gear carrier 24⁽¹⁰⁾; in addition, a secondary input shaft 14⁽¹⁰⁾ is rotationally fixedly coupled to the ring gear 19⁽¹⁰⁾ of the primary planetary gear 10⁽¹⁰⁾.

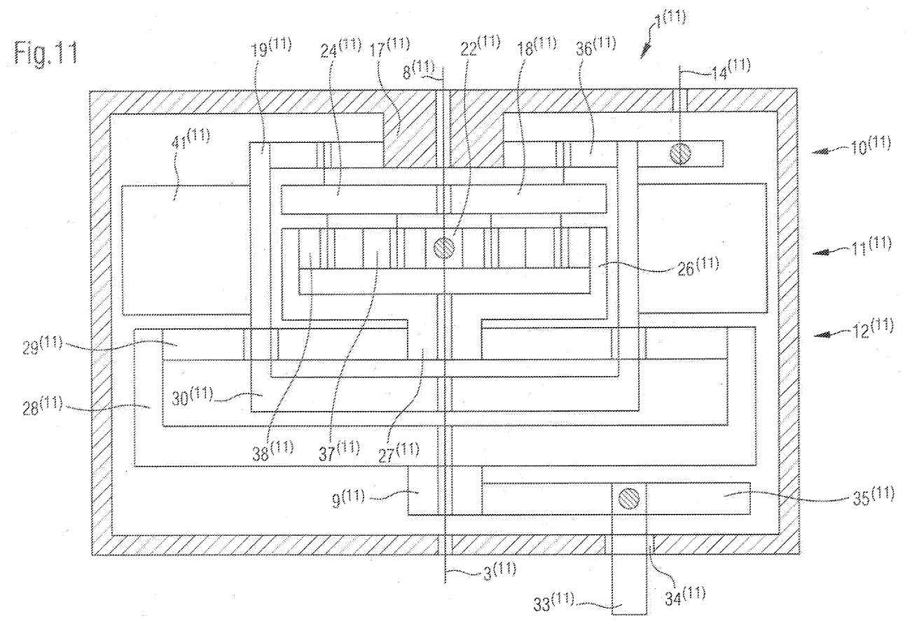

The freewheel mechanism 1⁽¹¹⁾ according to FIG. 11 is a further development of the previously described arrangement according to FIG. 10. Like those, it comprises three planetary gears 10⁽¹¹⁾, 11⁽¹¹⁾ and 12⁽¹¹⁾, which are arranged one behind the other in the longitudinal direction of the central shaft 3⁽¹¹⁾.

The primary planetary gear 10⁽¹¹⁾ is preferably identical in construction to the primary planetary gear 10⁽¹⁰⁾ of the freewheel mechanism 1⁽¹⁰⁾: the sun gear 17⁽¹¹⁾ is fixed to the housing 2⁽¹¹⁾, the planet gears 36⁽¹¹⁾ are mounted on the primary planet gear carrier 18⁽¹¹⁾, and the ring gear 19⁽¹¹⁾ is integrated or connected to the planet gear carrier 30⁽¹¹⁾ of the tertiary planetary gear 12⁽¹¹⁾ and can also be rotated by a power take-off shaft 14⁽¹¹⁾.

The tertiary planetary gear 12⁽¹¹⁾ differs from the embodiment according to FIG. 10 primarily in that the planet gears 29⁽¹¹⁾ are not arranged in pairs meshing with each other, but conventionally each individually bridge the gap between the ring gear 28⁽¹¹⁾, which is rotationally fixedly coupled to the output shaft 33⁽¹¹⁾, and the sun gear 27⁽¹¹⁾ and mesh with those elements.

As in FIG. 10, the sun gear 27⁽¹¹⁾ of the tertiary planetary gear 12⁽¹¹⁾ is integrated or connected to the ring gear 26⁽¹¹⁾ of the secondary planetary gear 11⁽¹¹⁾.

However, unlike the embodiment according to FIG. 10, the sun gear 22⁽¹¹⁾ of the secondary planetary gear 11⁽¹¹⁾ is driven via the central shaft 3⁽¹¹⁾ as the main drive shaft 11⁽¹¹⁾, while its planetary gear carrier 24⁽¹¹⁾ is integrated or connected to the planetary gear carrier 18⁽¹¹⁾ of the primary planetary gear 11⁽¹¹⁾.

In this freewheel mechanism 1⁽¹¹⁾, a flywheel 41 can additionally be provided in the form of an annular mass which surrounds the ring gear 19⁽¹¹⁾ of the primary planetary gear 10⁽¹¹⁾ on the outside.

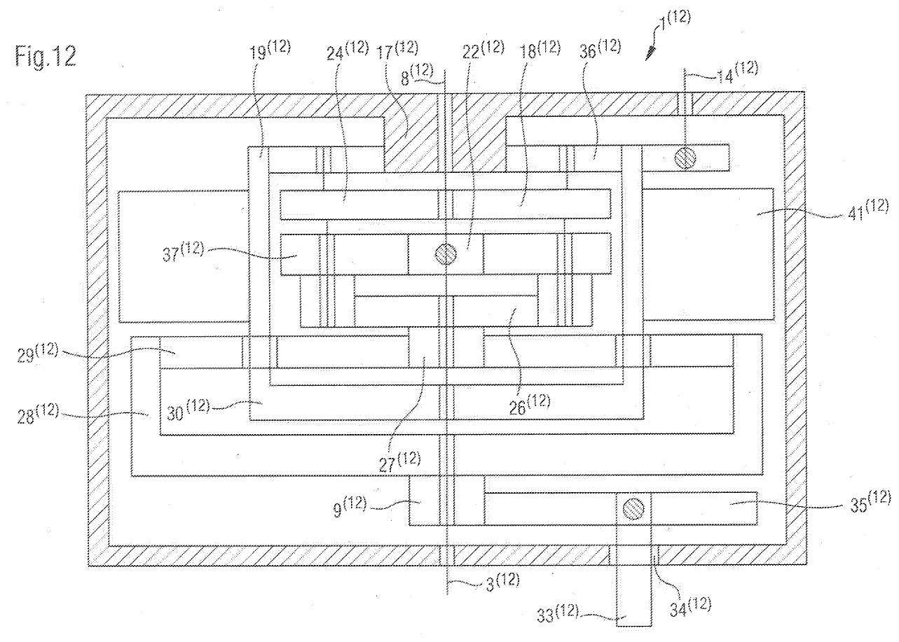

The freewheel mechanism 1⁽¹²⁾ according to FIG. 12 has a great similarity to the freewheel mechanism 1⁽¹¹⁾ according to FIG. 11. Here, too, there are three planetary gears 10⁽¹²⁾, 11⁽¹²⁾ and 12⁽¹²⁾, which are arranged one after the other along the central shaft 3⁽¹²⁾.

The most striking difference between the freewheel mechanism 1⁽¹²⁾ according to FIG. 12 and the freewheel mechanism 1⁽¹¹⁾ according to FIG. 11 is that the secondary or middle planetary gear 11⁽¹²⁾ does not have a ring gear but instead a second sun gear 26⁽¹²⁾, in addition to the first sun gear 22⁽¹²⁾. Both sun gears 22⁽¹²⁾, 26⁽¹²⁾ are offset against each other in the axial direction and have different diameters, and in order to be able to mesh with both sun gears 22⁽¹²⁾, 26⁽¹²⁾, the planet gears 37⁽¹²⁾ have a stepped geometry with two superimposed areas of different diameters, whereby the upper, cross-sectionally expanded area of a planet gear 37⁽¹²⁾ meshes with the smaller sun gear 22⁽¹²⁾, while the lower, cross-sectionally tapered area of the respective planet gear 37⁽¹²⁾ meshes with the larger sun gear 26⁽¹²⁾.

Overall, this results in a similar behavior to that of the freewheel mechanism 1⁽¹⁰⁾.

Also in this freewheel mechanism 1⁽¹²⁾, the ring gear 19⁽¹²⁾ of the primary planetary gear 10⁽¹²⁾ can be provided with an annular flywheel or tire 41⁽¹²⁾.

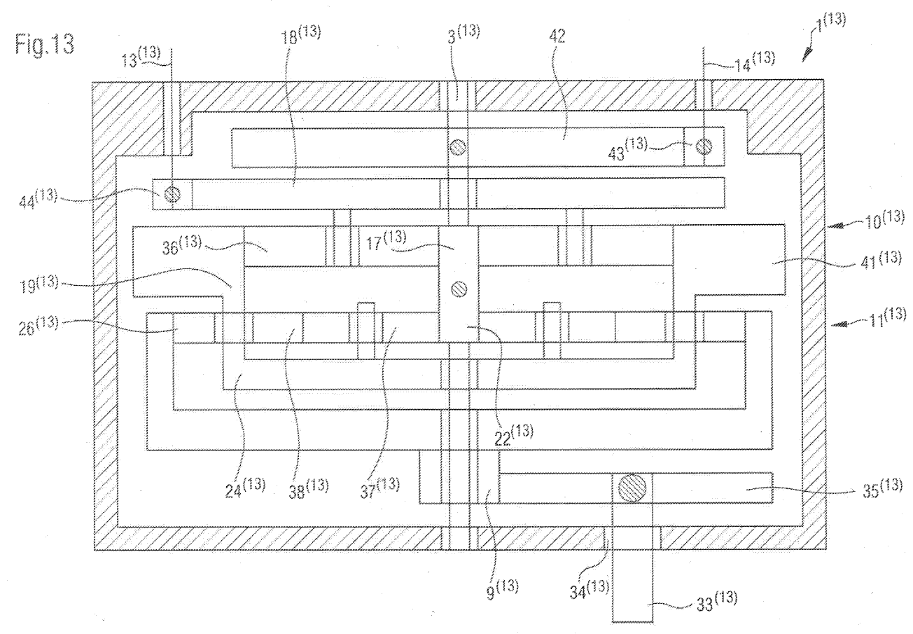

The freewheel mechanism 1⁽¹³⁾ according to FIG. 13 has a total of only two planetary gears 10⁽¹³⁾ and 11⁽¹³⁾, which together generate the freewheel function.

Both planetary gears 10⁽¹³⁾ and 11⁽¹³⁾ have a common sun gear 17⁽¹³⁾, 22⁽¹³⁾, or their two sun gears 17⁽¹³⁾ and 22⁽¹³⁾ are integrated or connected with each other so that there is no relative speed between them. This represents a coupling with a positive, standardized transmission ratio +1.

In addition, there is a rotational direction inverting coupling between the ring gear 19⁽¹³⁾ of the primary planetary gear 10⁽¹³⁾ and the ring gear 26⁽¹³⁾ of the secondary planetary gear 11⁽¹³⁾. This is a coupling with a negative transfer ratio −0.

In the freewheel mechanism 1⁽¹³⁾, the common sun gear 17⁽¹³⁾, 22⁽¹³⁾ is driven via the central shaft 3⁽¹³⁾, which is rotationally fixedly coupled to the drive shaft 14⁽¹³⁾ via the gear pair 42, 43 as a speed reduction gear.

A second drive shaft 13⁽¹³⁾ drives the planetary gear carrier 18⁽¹³⁾ of the primary planetary gear 10⁽¹³⁾ via an internal gear pinion 44.

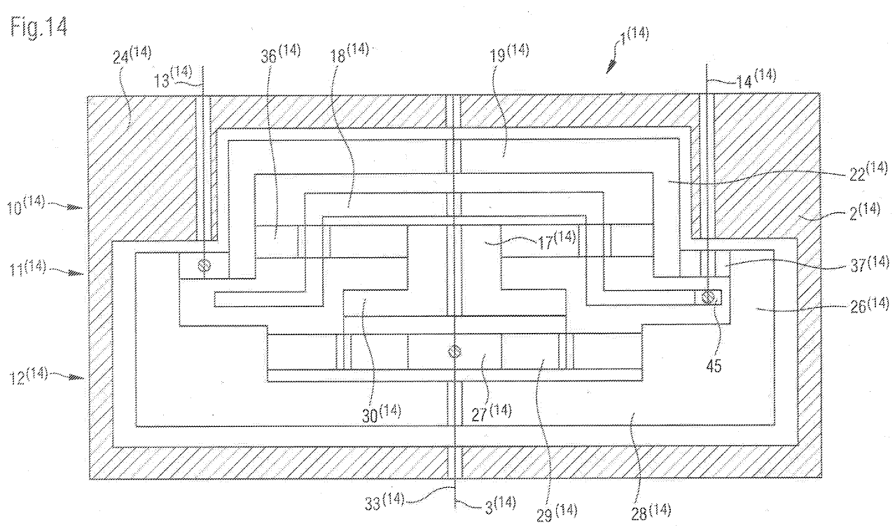

The freewheel mechanism 1⁽¹⁴⁾ according to FIG. 14 has three planetary gears 10⁽¹⁴⁾, 11⁽¹⁴⁾ and 12⁽¹⁴⁾.

There are two decentralized input shafts 13⁽¹⁴⁾ and 14⁽¹⁴⁾, which are coupled to the first two planetary gears 10⁽¹⁴⁾ and 11⁽¹⁴⁾, while the central shaft 3⁽¹⁴⁾ is non-rotatably connected to the sun gear 27⁽¹⁴⁾ of the tertiary planetary gear 12⁽¹⁴⁾ and serves as the output shaft 33⁽¹⁴⁾.

In particular, the drive or input shaft 13⁽¹⁴⁾ drives a planetary gear 37⁽¹⁴⁾ of the secondary planetary gear 11⁽¹⁴⁾, whereby the housing 2⁽¹⁴⁾ serves as a planetary gear carrier 24⁽¹⁴⁾, and the other drive or input shaft 14⁽¹⁴⁾ is non-rotatably coupled to the planet gear carrier 18⁽¹⁴⁾ of the primary planetary gear 10⁽¹⁴⁾ via a pinion 45.

The freewheel function is performed jointly by the secondary and tertiary planetary gears 11⁽¹⁴⁾ and 12⁽¹⁴⁾.

These are coupled to one another via a common ring gear 26⁽¹⁴⁾, 28⁽¹⁴⁾ in a rotationally maintaining manner, or the two ring gears 26⁽¹⁴⁾, 28⁽¹⁴⁾ are integrated or connected to one another for this purpose. The coupling or the transmission ratio üₖ is üₖ=+1.

In addition, a second coupling is made via the primary planetary gear 11⁽¹⁴⁾, in such a way that the sun gear 22⁽¹⁴⁾ of the secondary planetary gear 11⁽¹⁴⁾ is integrated or connected to the ring gear 19⁽¹⁴⁾ of the primary planetary gear 10⁽¹⁴⁾, and the planet gear carrier 30⁽¹⁴⁾ of the tertiary planetary gear 12⁽¹⁴⁾ is integrated or connected to the sun gear 17⁽¹⁴⁾ of the primary planetary gear 10⁽¹⁴⁾. The planetary gears 36⁽¹⁴⁾ are inserted between the sun gear 17⁽¹⁴⁾ of the primary planetary gear 10⁽¹⁴⁾ and its ring gear 19⁽¹⁴⁾, which cause a reversal of the direction of rotation because diametrically opposed circumferential areas, which move in opposite spatial directions during one revolution, mesh with the sun gear 17⁽¹⁴⁾ on the one hand and with the ring gear 19⁽¹⁴⁾ on the other hand. This results in the second, direction-inverting coupling with the negative transmission ratio üₖ=−k, with k>0.

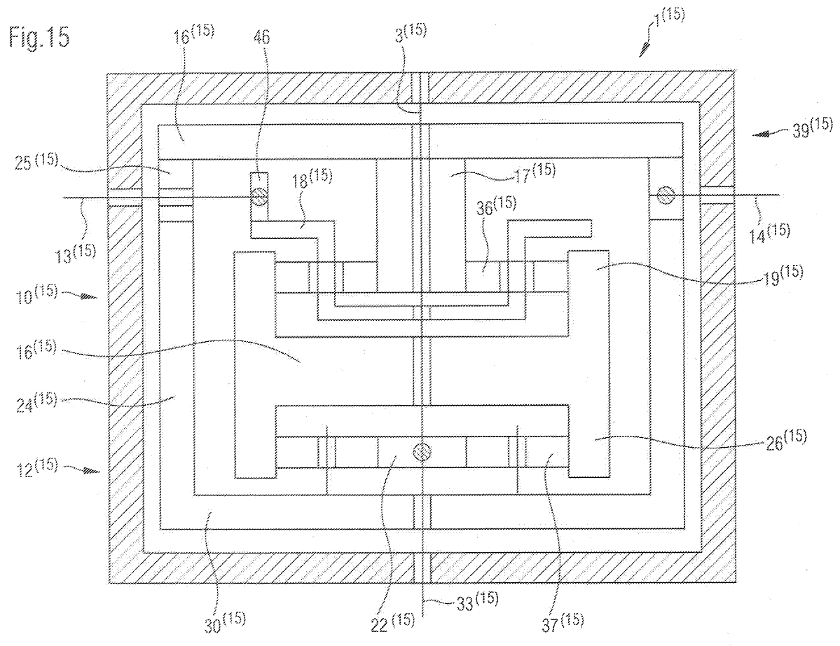

The freewheel mechanism 1⁽¹⁵⁾ according to FIG. 15 has only two planetary gears 10⁽¹⁵⁾ and 12⁽¹⁵⁾; however, there is also a structure 39⁽¹⁵⁾ of the type of a differential. In the interests of uniform counting of the epicyclic gears, the radially further inside, input-side planetary gear 10⁽¹⁵⁾ shall be referred to as the primary epicyclic gear 10⁽¹⁵⁾, which—with respect to its planetary gears 25⁽¹⁵⁾—is radially further outside horizontal, differential-type gear as secondary epicyclic gear 39⁽¹⁵⁾, and the output-side planetary gear 12⁽¹⁵⁾ as tertiary epicyclic gear 12⁽¹⁵⁾.

In this freewheel mechanism 1⁽¹⁵⁾, one of the planetary gears 25⁽¹⁵⁾ of the secondary differential-type planetary gear 39⁽¹⁵⁾ is driven by an input shaft 14⁽¹⁵⁾, with the housing 2⁽¹⁵⁾ serving as a planetary gear carrier, so to speak. The planetary gears 25⁽¹⁵⁾ mesh with an upper plate or disc 16⁽¹⁵⁾ and with a lower, trough-shaped structure 24⁽¹⁵⁾ of the secondary differential-type planetary gear 39⁽¹⁵⁾.

In addition, the planetary gear carrier 18⁽¹⁵⁾ of the primary planetary gear 10⁽¹⁵⁾ is driven via a second drive or input shaft 13⁽¹⁵⁾ and a pinion 46 connected thereto, which meshes with an all-round toothing on the respective planetary gear carrier 18⁽¹⁵⁾.

In this design, the primary and tertiary planetary gears 10⁽¹⁵⁾, 12⁽¹⁵⁾ take over the actual freewheel function.

The ring gear 19⁽¹⁵⁾ of the primary epicyclic gear 10⁽¹⁵⁾ is integrated or connected to the ring gear 26⁽¹⁵⁾ of the tertiary epicyclic gear 12⁽¹⁵⁾ and therefore always experiences the same speed as the latter; this coupling therefore corresponds to a coupling or transmission factor of üₖ=+1.

In addition, the sun gear 17⁽¹⁵⁾ of the primary epicyclic gear 10⁽¹⁵⁾ is integrated or connected to the upper disk 16⁽¹⁵⁾ of the differential gear-type secondary epicyclic gear 39⁽¹⁵⁾, while the planetary gear carrier 30⁽¹⁵⁾ of the tertiary epicyclic gear 12⁽¹⁵⁾ is integrated or connected to the lower trough-shaped rotating part 24⁽¹⁵⁾ of the differential gear-type secondary epicyclic gear 39⁽¹⁵⁾.

However, between the upper disk 16⁽¹⁵⁾ and the lower, preferably trough-shaped rotating part 24⁽¹⁵⁾ of the differential gear-like, secondary planetary gear 39⁽¹⁵⁾ there are the planetary gears 25⁽¹⁵⁾, which cause a reversal of the direction of rotation between these two rotating parts 16⁽¹⁵⁾ and 24⁽¹⁵⁾. Thus, this coupling between the sun gear 17⁽¹⁵⁾ of the primary epicyclic gear 10⁽¹⁵⁾ and the planet gear carrier 30⁽¹⁵⁾ of the tertiary epicyclic gear 12⁽¹⁵⁾ inverts the direction of rotation or has a coupling or speed transmission ratio of üₖ=−1.

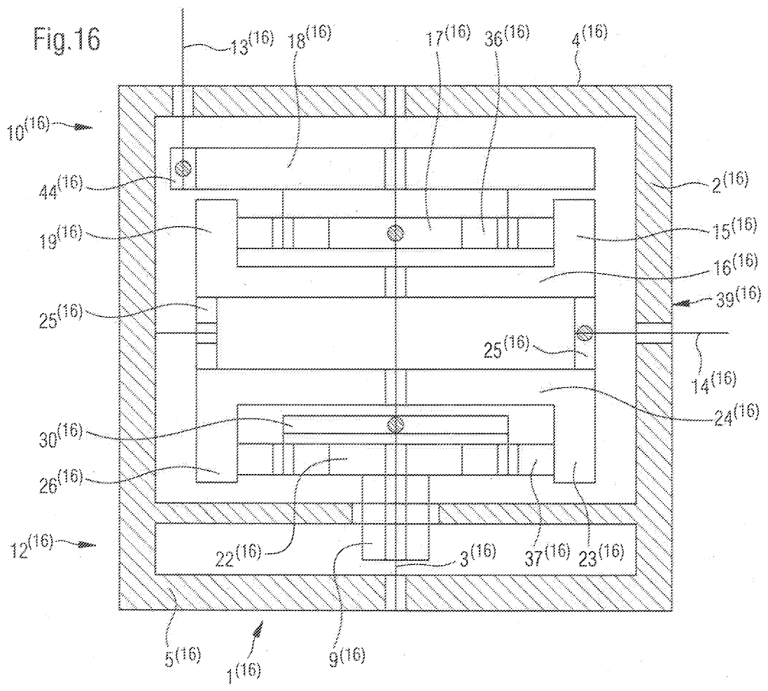

Finally, the freewheel mechanism 1⁽¹⁶⁾ according to FIG. 16 also has two planetary gears 10⁽¹⁶⁾ and 12⁽¹⁶⁾ as well as a structure 39⁽¹⁶⁾ of the type of a differential. In order to ensure a uniform numbering of the epicyclic gears, the planetary gear 10⁽¹⁶⁾, which is located radially further inwards on the input side, is to be referred to as the primary epicyclic gear 10⁽¹⁶⁾, the differential-type gear which is located radially further outwards with respect to its epicyclic gears 25⁽¹⁶⁾ is to be referred to as the secondary epicyclic gear 39⁽¹⁶⁾, and the planetary gear 12⁽¹⁶⁾ on the output side is to be referred to as the tertiary epicyclic gear 12⁽¹⁶⁾.

In this embodiment—similar to the arrangement according to FIG. 13—a first decentralized input shaft 13⁽¹⁶⁾ acts on the planet gear carrier 18⁽¹⁶⁾ via a pinion 44⁽¹⁶⁾ applied thereto.

A second ring gear 26⁽¹⁶⁾, with which the planet gears 37⁽¹⁶⁾ mounted on the planet gear carrier 24⁽¹⁶⁾ of the tertiary epicyclic gear 12⁽¹⁶⁾ mesh, is arranged in a mirror image with respect to an approximately central plane of symmetry through which the central axis 3⁽¹⁶⁾ perpendicularly passes to the ring gear 19⁽¹⁶⁾, with which the planet gears 36⁽¹⁶⁾ mounted on the planet gear carrier 18⁽¹⁶⁾ mesh, with respect, and.

The two ring gears 19⁽¹⁶⁾, 26⁽¹⁶⁾ each have an internally toothed ring 15⁽¹⁶⁾, 23⁽¹⁶⁾ as well as a circular disc 16⁽¹⁶⁾, 24⁽¹⁶⁾ attached to the side with a central hole for mounting on the central shaft 3⁽¹⁶⁾. However, unlike the arrangement according to FIG. 1, the two internally toothed rings 15⁽¹⁶⁾, 23⁽¹⁶⁾ face away from each other and the two circular disks 16⁽¹⁶⁾, 24⁽¹⁶⁾ face each other or the common plane of symmetry.

Unlike the embodiment according to FIG. 15, where the two ring gears 19⁽¹⁵⁾, 26⁽¹⁵⁾ are formed together with their respective circular disks 16⁽¹⁵⁾, 24⁽¹⁵⁾, i.e. integrated or connected to one another, there is a gap of constant width between the circular disks 16⁽¹⁶⁾, 24⁽¹⁶⁾ of the freewheel mechanism 1⁽¹⁶⁾, and several planetary gears 25⁽¹⁶⁾ roll in this gap, which mesh with the two ring gears 19⁽¹⁶⁾, 26⁽¹⁶⁾ on those or on the mutually facing surfaces of the two circular disks 16⁽¹⁶⁾, 24⁽¹⁶⁾ in the sense of a rotationally fixed coupling.

One of the planetary gears 25⁽¹⁶⁾ is rotationally fixedly coupled to a drive or input shaft 14⁽¹⁶⁾ arranged on the housing shell side.

The output shaft is not shown in this figure; however, a decentralized output shaft could mesh with the pinion 9⁽¹⁶⁾ via a pinion, similar to the arrangement according to FIG. 1.

The freewheel function is carried out jointly by the primary and tertiary planetary gears 10⁽¹⁶⁾ and 12⁽¹⁶⁾, which are coupled together in two different ways for this purpose.

A first coupling is achieved by the sun gear 17⁽¹⁶⁾ of the primary epicyclic gear 10⁽¹⁶⁾ being rotationally fixedly connected to the planet gear carrier 24⁽¹⁶⁾ of the tertiary epicyclic gear 12⁽¹⁶⁾ via the central shaft 3⁽¹⁶⁾. Both rotating parts 17⁽¹⁶⁾, 24⁽¹⁶⁾ always rotate at the same speed—their coupling or speed transmission ratio is üₖ=+1.

In addition, there is a second coupling between the two ring gears 19⁽¹⁶⁾ and 26⁽¹⁶⁾ of the primary and tertiary epicyclic gears 10⁽¹⁶⁾ and 12⁽¹⁶⁾, whereby, due to the epicyclic gears 25⁽¹⁶⁾ rolling between them, a change in the direction of rotation takes place, such that the two ring gears 19⁽¹⁶⁾ and 26⁽¹⁶⁾ always rotate at the same speed, but in opposite directions of rotation—their coupling or the speed transmission ratio is therefore always üₖ=−1.

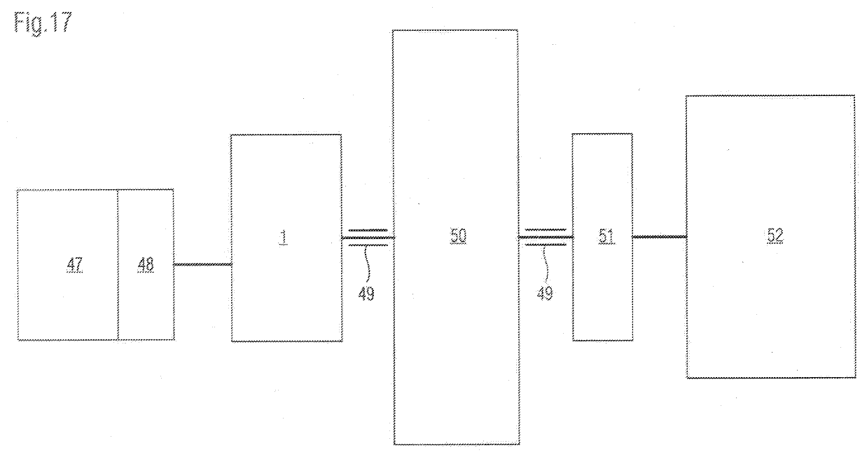

Finally, an application example for a freewheel mechanism 1 according to the invention will be explained with reference to FIG. 17, wherein—as in other applications—all previously described freewheel mechanisms can be used.

In FIG. 17, an energy converter 47 is shown on the left, which converts other supplied forms of energy into mechanical rotational energy. This could be a wind turbine, or a propeller or turbine of a hydroelectric power plant, but also an internal combustion engine powered by wood or biogas, natural gas, petrol or diesel, etc.

This energy converter 47 can be followed by a step-up or step-down gear 48 in order to transform a possibly unfavorable speed range of the energy converter 47 into a speed range that is more suitable for the subsequent components.

Downstream of the gear 48 is a freewheel mechanism 1 according to the invention, which serves the purpose of keeping this drop in speed away from the downstream components of a wind turbine in the event of a brief drop in speed at the energy converter 47—for example as a result of a gust of wind.

A flywheel 50 or another flywheel mass is then coupled to the output shaft of the freewheel mechanism 1, which rotatably supported by one or more bearing 49. In the event of a brief drop in speed at the energy converter 47, the rotating mass of this flywheel 50 is responsible for keeping the speed of the subsequent components constant for as long as possible in order to bridge this drop in speed.

A generator 52 is then coupled to a further shaft connection of the flywheel—preferably via a further transmission gear 51—which converts the mechanical rotational energy into electrical energy, which can then either be consumed on site or stored or fed into a power grid.

In such an arrangement, the inventive freewheel mechanism 1 operates fully automatically, meaning that, i.e., if the speed at the input of the freewheel mechanism 1 drops compared to the speed at the output, the latter automatically enters freewheel mode, and because there is no interruption in the gear engagement, the load transmission can be resumed immediately as soon as the speed at the input of the freewheel mechanism has increased again and a torque can be transmitted from the input to the output shaft.

Due to its compact design, a filing mechanism 1 according to the invention can be installed, for example, in the nacelle of a wind turbine and can always be connected to the drive train between the wind turbine 47 and the generator 52.

As can be seen from the above examples, at least two of possibly several epicyclic gears are always coupled to one another in two different ways, namely on the one hand in such a way that a rotary connection of the two epicyclic gears involved rotates in the same direction of rotation, and on the other hand in such a way that a (different) rotary connection of each of the two epicyclic gears involved rotates in the opposite direction of rotation. At least one of these couplings can be standardized in such a way that the rotating parts involved rotate at the same speed.

A coupling of two rotating parts with the same direction of rotation can be achieved particularly easily by integrating the two rotating parts with each other or connecting them with each other, i.e. fixing them non-rotatably. Then the coupling or speed transmission ratio between these rotating parts +1.

A coupling of two rotating parts with opposite directions of rotation can be achieved particularly easily by not having the two rotating parts mesh directly with each other, but by interposing a coupling gear that meshes with both rotating parts. There can also be several such coupling gears, all of which are in engagement with both rotating parts.

If the axis of rotation(s) of such a coupling gear(s) run radially to the central axis 3 of the freewheel mechanism 1, while the rotating parts coupled thereto are displaced against one another along the central axis 3 in order to make room for the one or more coupling gears, a coupling or transmission ratio between these rotating parts of −1 can be achieved. Such an arrangement is comparable to the planetary gears of a differential gear.

In another embodiment, the axis of rotation(s) of such coupling gear(s) may run parallel to the central axis 3 of the freewheel mechanism 1. In this case, the rotating parts involved or meshing with them should be designed as a ring gear on the one hand and as a sun gear on the other. Such an arrangement is comparable to the planet gears of a planetary gear. With a such an arrangement a negative coupling or speed transmission ratio between these rotating parts of −ü can be achieved; a coupling or a speed transmission ratio of −1 fails due to the different radii of the gears on the ring gear on the one hand and the sun gear on the other.

A freewheel mechanism according to the invention, regardless of its design, can be used as a freewheel transmission, continuously variable transmission, flywheel transmission, hybrid transmission, etc.

Possible areas of application include the automotive industry, rail vehicles, aviation applications, shipping applications, motorcycles or bicycles [bitte überprüfen], e.g. pedelecs or e-bikes, drives in machine tools or in all other work machines such as e.g. textile weaving machines, cranes or other industrial trucks, tunnel boring machines, in particular applications in connection with robotics or other controlled or regulated drives, in the area of power plants or for connecting generators to energy converters of any kind.

List of reference symbols

| | |
|---|---|
| 1 | Freewheel mechanism |
| 2 | Housing |
| 3 | Shaft |
| 4 | Front side |
| 5 | Front side |
| 6 | Bearing |
| 7 | Bearing |
| 8 | End |
| 9 | Toothed wheel |
| 10 | Planetary gear |
| 11 | Planetary gear |
| 12 | Planetary gear |
| 13 | Input shaft |
| 14 | Input shaft |
| 15 | Ring gear |
| 16 | Disk |
| 17 | Sun gear |
| 18 | Planet carrier |
| 19 | Ring gear |
| 20 | Bearing |
| 21 | Storage |
| 22 | Sun gear |
| 23 | Toothed wheel |
| 24 | Planetary gear carrier |
| 25 | Toothed wheel |
| 26 | Ring gear |
| 27 | Sun gear |
| 28 | Toothing |
| 29 | Planetary gear |
| 30 | Planetary gear carrier |
| 31 | Cage |
| 32 | Bevel or crown gear |
| 33 | Output shaft |
| 34 | Bearing point |
| 35 | Toothed wheel |
| 36 | Planetary gear |
| 37 | Planetary gear |
| 38 | Planetary gear |
| 39 | Differential gear |
| 40 | Bevel or crown gear |
| 41 | Flywheel |
| 42 | Toothed wheel |
| 43 | Toothed wheel |
| 44 | Toothed wheel |
| 45 | Toothed wheel |
| 46 | Toothed wheel |
| 47 | Energy converters |
| 48 | Transmission gear |
| 49 | Bearings |
| 50 | Flywheel |
| 51 | Transmission gear |
| 52 | Generator |

1. Freewheel mechanism (1), comprising:
a) at least one input shaft (3;8;13;14) rotating at an input speed (ω_{E});
b) at least one output shaft (3;33) rotating at an output speed (ω_{A});
c) a first differential or planetary gear (10;11;12;39) arranged therebetween, comprising at least one toothed orbital pinion or planetary wheel (25;29;36;37) rotatably mounted in a first orbital gear or planetary gear carrier (2;18;24;30), which meshes with two internal gear rings at two further rotary connections of the first differential or planetary gear (10;11;12;39), the rotational speeds (ω₁₂, ω₁₃) of which determine the rotational speed (ω₁₁) of the first orbital gear or planetary gear carrier (2;18;24;30) in the first differential or planetary gear (10;11;12;39);
d) a second differential or planetary gear (10;11;12;39), comprising at least one toothed orbital pinion or planetary wheel (25;29;36;37) rotatably mounted in a second orbital gear or planetary gear carrier (2;18;24;30), which meshes with two internal gear rings on two further rotary connections of the second differential or planetary gear (10;11;12;39), the speeds (ω₂₂, ω₂₃) of which determine the speed (ω₂₁) of the second orbital gear or planetary gear carrier (2;18;24;30) in the second differential or planetary gear (10;11;12;39);
e) a housing (2) in which both or all of the differential or planetary gears (10;11;12;39) are accommodated;
characterized in that
f) both or all differential or planetary gear units (10;11;12;39) are constructed with one single, common rotational shaft which is pivotally mounted in the housing (2) in the regions of its both ends (8), and which is coupled to one of the three coaxial rotating parts rotate, i.e. the orbital gear carrier or the planetary gear carrier (2;18;24;30) or to one of the two rotating connections of the two differential or planetary gear units (10;11;12;39) in such a way that it rotates along with that, while all other rotating parts of the differential or planetary gear units (10;11;12;39) are pivotally mounted on the common continuous shaft (3).

2. Freewheel mechanism (1) according to claim 1, characterized in that at least one orbital gear carrier or planetary gear carrier (2;18;24;30) of the first or second differential or planetary gear (10;11;12;39) is neither coupled nor integrated with the at least one input shaft (8;13;14) nor with the at least one output shaft (33).

3. Freewheel mechanism (1) according to claim 1, characterized in that a rotary connection of the first differential or planetary gear (10;11;12;39), the internal gear ring of which meshes with at least one orbital pinion or planetary wheel (25;29;36;37) of the first differential or planetary gear (10;11;12;39), is coupled to one of the three rotary connections of the second differential or planetary gear (10;11;12;39) in such a way that these two coupled rotary connections rotate at the same speed and in the same direction of rotation.

4. Freewheel mechanism (1) according to claim 1, characterized in that the two mutually coupled rotary connections of the first and second differential or planetary gear (10;11;12;39), which rotate at the same speed and in the same direction of rotation due to their coupling, are neither coupled nor integrated with the input shaft (8;13;14) nor with the output shaft (33).

5. Freewheel mechanism (1) according to claim 1, characterized in that another rotary connection of the first differential or planetary gear (10;11;12;39), the internal gear ring of which meshes with at least one orbital pinion or planetary wheel (25;29;36;37) of the first differential or planetary gear (10;11;12;39), is coupled to another one of the three rotary connections of the second differential or planetary gear (10;11;12;39) in such a way that these two mutually coupled rotary connections rotate at opposed identical speeds.

6. Freewheel mechanism (1) according to claim 1, characterized in that one or both or all differential or planetary gears (10;11;12;39) are constructed with crown gears (25) or with bevel gears.

7. Freewheel mechanism (1) according to claim 1, characterized in that it is set to a fixed transmission ratio ü=ω_{A}/ω_{E}, so that the output speed ω_{A} is:
$${ω}_{A} = \ddot{u} * {ω}_{E} ,$$
as long as no external torque or counter-torque working in the opposite direction of rotation acts on the output shaft and/or on at least one rotary connection of the second differential or planetary gear (10;11;12;39).

8. Freewheel mechanism (1) according to claim 7, characterized in that in case of an external torque on the output shaft (33) or on at least one rotary connection of the second differential or planetary gear (10;11;12;39) in the respective output direction of rotation, it applies:
$$\vert {ω}_{A} \vert > \vert \ddot{u} * {ω}_{E} \vert .$$

9. Freewheel mechanism (1) according to claim 1, characterized by a first rotational coupling between a rotary connection not coupled to the respective orbital pinion or planetary gear carrier (2;18;24;30) of two different differential or planetary gears (10;11;12;39), preferably of the first and second differential or planetary gears (10;11;12;39), in particular such that their rotational speeds are identical.

10. Freewheel mechanism (1) according to claim 1, characterized by a second rotary coupling between two different differential or planetary gears (10;11;12;39) such that the speeds of the coupled rotary connections are oppositely identical.

11. Freewheel mechanism (1) according to claim 1, characterized in that the input shaft is coupled to a first differential or planetary gear (10;11;12;39), preferably in a symmetrical manner, i.e. in particular, only to the orbital pinion carrier or planetary gear carrier (2;18;24;30) thereof.

12. Freewheel mechanism (1) according to claim 1, characterized in that the output shaft is coupled to a second differential or planetary gear (10;11;12;39), preferably in an asymmetrical manner, i.e. preferably not or not only to the orbital pinion carrier or planetary gear carrier (2;18;24;30) thereof, but optionally also to a rotary connection of the second differential or planetary gear (10;11;12;39), the internal ring gear of which meshes with at least one toothed orbital pinion or planetary gear (25;29;36;37).

13. Freewheel mechanism (1) according to claim 1, characterized in that the output shaft (33) is coupled to a third differential or planetary gear (10;11;12;39), wherein the third differential or planetary gear (10;11;12;39) is preferably coupled to two rotary connections of the second differential or planetary gear (10;11;12;39), preferably in an asymmetrical manner, i.e. with the orbital pinion carrier or planetary gear carrier (2;18;24;30) thereof on the one hand and with a rotary connection of the second differential or planetary gear (10;11;12;39), the internal gear ring of which meshes with at least one toothed orbital pinion or planetary gear of the second differential or planetary gear (10;11;12;39).

14. Freewheel mechanism (1) according to claim 1, characterized in that at least one of the two rotary connections of the first differential or planetary gear (10;11;12;39) coupled to the second differential or planetary gear (10;11;12;39) remains unaffected from the outside, so that its speed (ω₁₂, ω₁₃) can adjust itself freely, in particular opposite to the other rotary connection of the first differential or planetary gear (10;11;12;39) coupled to the second differential or planetary gear (10;11;12;39), if necessary, additionally to twice the speed (ω₁₁) of the first orbital or planetary gear carrier, if a co-torque working in the direction of rotation acts on the output shaft (33) and/or on at least one rotary connection of the second differential or planetary gear (10;11;12;39), so that under the influence of this co-torque the output speed (ω_{A}) can increase without the input speed (ω_{E}) being influenced thereby.

15. Freewheel mechanism (1) according to claim 1, characterized in that by influencing a single coupling gear between the first and second differential or planetary gear (10;11;12;39), the freewheel function is switched off, preferably by bringing the relevant coupling gear into a non-rotatable state in order to switch off the freewheel function, wherein in particular the coupling gear is fastened to a multiply cranked shaft, which in turn is eccentrically mounted in at least one disk, which itself is rotatably received in a pivotable and/or displaceable ring-shaped lunette.

16. Freewheel mechanism (1) according to claim 1, characterized in that at least one coupling between the first differential or planetary gear (10;11;12;39) and the second differential or planetary gear (10;11;12;39), preferably that coupling whose mutually coupled rotary connections of the first and second differential or planetary gear (10;11;12;39) rotate at the same speed and in the same direction of rotation due to this coupling, in particular both couplings between those differential or planetary gears (10;11;12;39), is neither accessible nor influenceable from the outside, and preferably internally at most via a pivotable and/or movable ring-shaped lunette, which cooperates with a region of a multi-cranked shaft of a toothed wheel of the coupling in question, which runs eccentrically to the axis of rotation of this toothed wheel.

17. Freewheel mechanism (1) according to claim 1, characterized in that the common shaft (3) can be designed as an input shaft rotating at an input speed (ω_{E}).

18. Freewheel Mechanism (1) according to claim 1, characterized in that the common shaft (3) is the output shaft rotating at an output speed (ω_{A}).

19. Freewheel mechanism (1) according to claim 1, characterized by a second and, possibly, a third input shaft (13;14), which rotates with its own input speed (ω_{E2}, ω_{E3}).

20. Freewheel mechanism (1) according to claim 19, characterized in that the second and, possibly, the third input shaft (13;14) is arranged decentrally to the central shaft (3) in a front face (4) of the housing (2), or radially to the decentralized shaft (3) in a lateral face of the housing (2).

21. Freewheel mechanism (1) according to claim 19, characterized in that the input speeds (ω_{E}, ω_{E2}, ω_{3E}) of all input shafts (8;13;14) on or before the first differential or planetary gear (10;11;12;39) are combined, for example added together or added in a weighted manner.

22. Freewheel mechanism (1) according to claim 1, characterized in that the output shaft rotating at an output speed (ω_{A}) is coupled to the second, third or a further differential or planetary gear (10;11;12;39).

23. Freewheel mechanism (1) according to claim 1, characterized in that the output shaft (33) is mounted eccentrically to the input shaft (8).

24. Freewheel mechanism (1) according to claim 1, characterized in that the sun and hollow gears and planetary wheel carriers (2;18;24;30) of all planetary gears (10;11;12;39) as well as the central shafts and orbital pinion carriers (2;18;24;30) of all differential gears (10;11;12;39) rotate around the same central shaft (3) of the freewheel mechanism (1).

25. Freewheel mechanism (1) according to claim 1, characterized in that the housing (2) is rotationally symmetrical.

26. Drive train of a vehicle, comprising a freewheel mechanism (1) according to claim 1, characterized in that the freewheel mechanism (1) is engaged in the drive train in such a way that in overrun mode the freewheel function decouples the drive motor from the drive train to the wheels, and/or in such a way that it is engaged between the drive train (47,48) and a flywheel (50), and/or in such a way that it is engaged between the drive train and a starter or between a flywheel and a starter.
